(19) United States
(12) Patent Application Publication
(10) Pub. No.: US 2025/0106870 A1
(43) Pub. Date: Mar. 27, 2025

(54) DYNAMIC TRANSFORM PRECODING INDICATION FOR PHYSICAL UPLINK SHARED CHANNEL AND/OR MSG3 TRANSMISSION

(71) Applicant: Intel Corporation, Santa Clara, CA (US)

(72) Inventors: Gang Xiong, Portland, OR (US); Guotong Wang, Santa Clara, CA (US); Prerana Rane, Santa Clara, CA (US)

(21) Appl. No.: 18/832,842

(22) PCT Filed: Apr. 4, 2023
(86) PCT No.: PCT/US2023/065326

§ 371 Date: Jul. 24, 2024

Related U.S. Application Data
(60) Provisional application No. 63/327,681, filed on Apr. 5, 2022.
(60) Provisional application No. 63/410,996, filed on Sep. 28, 2022.
(60) Provisional application No. 63/421,023, filed on Oct. 31, 2022.
(60) Provisional application No. 63/483,684, filed on Feb. 7, 2023.

(51) Int. Cl. H04W 72/232; H04L 27/00; H04L 27/26; H04W 74/0833

(52) U.S. Cl. CPC H04W 72/232; H04L 27/0008; H04L 27/2636; H04W 74/0833

(57) ABSTRACT

Various embodiments herein provide techniques for dynamic transform precoding indication for a physical uplink shared channel (PUSCH) transmission and/or a msg3 transmission associated with a random access channel (RACH) procedure. For example, a downlink control information (DCI) that schedules a PUSCH may include a field to indicate whether transform precoding is enabled or disabled for the PUSCH. Additionally, or alternatively, the uplink grant received in the msg2 of the RACH procedure may include an indication of whether transform precoding is enabled or disabled for the msg3. Other embodiments may be described and claimed.

### CROSS REFERENCE TO RELATED APPLICATION

The present application claims priority to U.S. Provisional Patent Application No. 63/327,681, which was filed Apr. 5, 2022; U.S. Provisional Patent Application No. 63/410,996, which was filed Sep. 28, 2022; U.S. Provisional Patent Application No. 63/421,023, which was filed Oct. 31, 2022; and to U.S. Provisional Patent Application No. 63/483,684, which was filed Feb. 7, 2023.

### FIELD

Various embodiments generally may relate to the field of wireless communications. For example, some embodiments may relate to dynamic transform precoding indication for physical uplink shared channel (PUSCH) transmission and/or msg3 transmission associated with a random access channel (RACH) procedure.

### BACKGROUND

Mobile communication has evolved significantly from early voice systems to today's highly sophisticated integrated communication platform. The next generation wireless communication system, 5G, or new radio (NR) will provide access to information and sharing of data anywhere, anytime by various users and applications. NR is expected to be a unified network/system that target to meet vastly different and sometime conflicting performance dimensions and services. Such diverse multi-dimensional requirements are driven by different services and applications. In general, NR will evolve based on 3GPP LTE-Advanced with additional potential new Radio Access Technologies (RATs) to enrich people lives with better, simple, and seamless wireless connectivity solutions. NR will enable everything connected by wireless and deliver fast, rich contents and services.

For cellular system, coverage is an important factor for successful operation. Compared to LTE, NR can be deployed at relatively higher carrier frequency in frequency range 1 (FR1), e.g., at 3.5 GHz. In this case, coverage loss is expected due to larger path-loss, which makes it more challenging to maintain an adequate quality of service. Typically, uplink coverage is the bottleneck for system operation considering the low transmit power at UE side.

### BRIEF DESCRIPTION OF THE DRAWINGS

Embodiments will be readily understood by the following detailed description in conjunction with the accompanying drawings. To facilitate this description, like reference numerals designate like structural elements. Embodiments are illustrated by way of example and not by way of limitation in the figures of the accompanying drawings.

FIG. 1 illustrates a 4-step random access channel (RACH) procedure.

FIG. 2 illustrates a RACH procedure with dynamic transform precoding indication, in accordance with various embodiments.

FIG. 3 schematically illustrates a wireless network in accordance with various embodiments.

FIG. 4 schematically illustrates components of a wireless network in accordance with various embodiments.

FIG. 5 is a block diagram illustrating components, according to some example embodiments, able to read instructions from a machine-readable or computer-readable medium (e.g., a non-transitory machine-readable storage medium) and perform any one or more of the methodologies discussed herein.

FIG. 6 depicts an example procedure for practicing the various embodiments discussed herein.

FIG. 7 depicts another example procedure for practicing the various embodiments discussed herein.

FIG. 8 depicts another example procedure for practicing the various embodiments discussed herein.

### DETAILED DESCRIPTION

The following detailed description refers to the accompanying drawings. The same reference numbers may be used in different drawings to identify the same or similar elements. In the following description, for purposes of explanation and not limitation, specific details are set forth such as particular structures, architectures, interfaces, techniques, etc. in order to provide a thorough understanding of the various aspects of various embodiments. However, it will be apparent to those skilled in the art having the benefit of the present disclosure that the various aspects of the various embodiments may be practiced in other examples that depart from these specific details. In certain instances, descriptions of well-known devices, circuits, and methods are omitted so as not to obscure the description of the various embodiments with unnecessary detail. For the purposes of the present document, the phrases “A or B” and “A/B” mean (A), (B), or (A and B).

Various embodiments herein provide techniques for dynamic transform precoding indication for a physical uplink shared channel (PUSCH) transmission and/or a msg3 transmission associated with a random access channel (RACH) procedure. For example, a downlink control information (DCI) that schedules a PUSCH may include a field to indicate whether transform precoding is enabled or disabled for the PUSCH. In some embodiments, the DCI is a DCI format 0_0, a DCI format 0_1, or a DCI format 0_2. Additionally, or alternatively, in some embodiments, the DCI has a cyclic redundancy check (CRC) scrambled by a cell (C)-radio network temporary identifier (RNTI), a configured scheduling (CS)-RNTI, a semi-persistent-channel state information (SP-CSI)-RNTI, or a modulation and coding scheme (MCS)-C-RNTI.

Embodiments also provide techniques for dynamic transform precoding indication for transmission of msg3 (e.g., initial transmission or retransmission(s)) in a random access procedure. For example, the uplink grant received in the msg2 of the random access procedure may include an indication of whether transform precoding is enabled or disabled for the msg3. In some embodiments, the indication may be in a designated field and/or may use one or more bits of a field that also encodes other information (e.g., by repurposing an existing field).

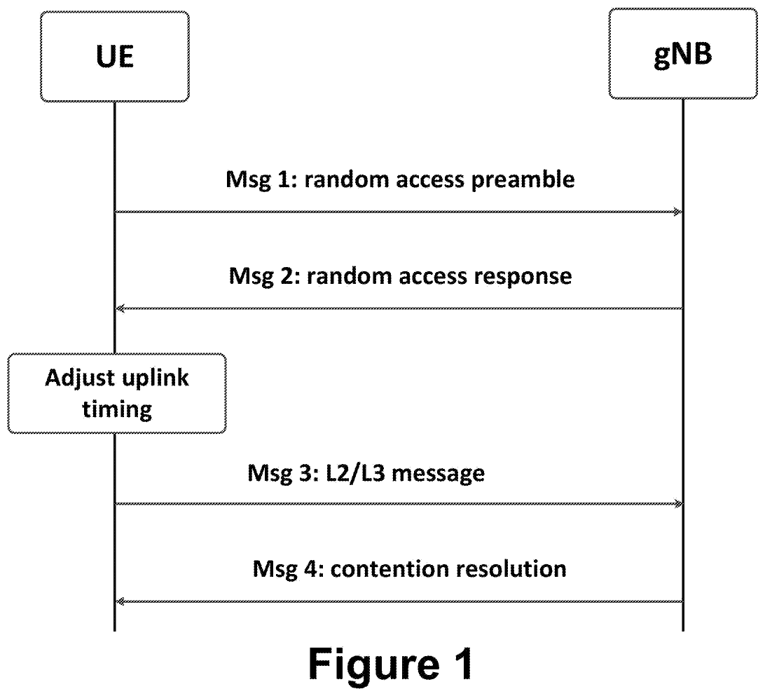

In NR Rel-15, a 4-step random access channel (RACH) procedure was defined. FIG. 1 illustrates the 4-step RACH procedure for initial access. In the first step, the user equipment (UE) transmits physical random access channel (PRACH) in the uplink (UL) by randomly selecting one preamble signature, which would allow gNB to estimate the delay between gNB and UE for subsequent UL timing adjustment. Subsequently, in the second step, gNB feedbacks the random access response (RAR) which carries timing advanced (TA) command information and uplink grant for the uplink transmission in the third step. The UE expects to receive the RAR within a time window, of which the start and end are configured by the gNB via system information block (SIB). Then, according to the UL grant in the RAR, UE can transmit a UL message (Msg3) which includes an identity of the UE. Finally, after successful reception of msg3, the gNB can transmit a downlink (DL) message (Msg4) which serves as contention resolution for the UE.

In NR, system design is based on waveform choice of cyclic prefix-orthogonal frequency-division multiplexing (CP-OFDM) for DL and UL, and additionally, Discrete Fourier Transform-spread-OFDM (DFT-s-OFDM) for UL. Note that DFT-s-OFDM waveform is realized by enabling transform precoding at the transmitter side. When transform precoding is disabled, CP-OFDM waveform is employed for PUSCH transmission. Typically, DFT-s-OFDM waveform can achieve better uplink coverage performance due to its low Peak-to-Average Power Ratio (PAPR) compared to CP-OFDM waveform.

The waveform used for the Msg3 transmission is configured by NR remaining minimum system information (RMSI). For 4-step RACH, coverage enhancement is essential for proper system operation given the fact that initial access is the first step for UE to access the network. In order to further improve the coverage for Msg3 transmission, certain mechanisms may need to be defined to allow dynamic transform precoder indication for Msg3 transmission.

Various embodiments herein provide techniques for dynamic transform precoding indication for Msg3 transmission. For example, aspects of various embodiments may include:
Dynamic transform precoding indication for Msg3 initial transmission
Dynamic transform precoding indication for Msg3 retransmission
Dynamic transform precoding indication for PUSCH transmission

### Dynamic Transform Precoding Indication for Msg3 Initial Transmission

As mentioned above, in NR, system design is based on waveform choice of cyclic prefix-orthogonal frequency-division multiplexing (CP-OFDM) for DL and UL, and additionally, Discrete Fourier Transform-spread-OFDM (DFT-s-OFDM) for UL. Note that DFT-s-OFDM waveform is realized by enabling transform precoding at the transmitter side. When transform precoding is disabled, CP-OFDM waveform is employed for PUSCH transmission. Typically, DFT-s-OFDM waveform can achieve better uplink coverage performance due to its low Peak-to-Average Power Ratio (PAPR) compared to CP-OFDM waveform.

Note that waveform used for the Msg3 transmission is configured by NR remaining minimum system information (RMSI). For 4-step RACH, coverage enhancement is essential for proper system operation given the fact that initial access is the first step for UE to access the network. In order to further improve the coverage for Msg3 transmission, certain mechanisms may need to be defined to allow dynamic transform precoding indication for Msg3 transmission.

In the following embodiments, Msg3 initial transmission is the Msg3 transmission which is scheduled by RAR UL grant. Further, Msg3 retransmission is the Msg3 transmission which is scheduled by a DCI format 0_0 with Cyclic Redundancy Check (CRC) scrambled by a Temporary Cell-Radio Network Temporary Identifier (TC-RNTI).

Aspects of various embodiments for dynamic transform precoding indication for Msg3 initial transmission are described further below.

In one embodiment, enabling/disabling transform precoding for CP-OFDM and DFT-s-OFDM waveform generation can be indicated in the RAR UL grant for Msg3 initial transmission. In particular, in order to maintain the same size for RAR UL grant and ensure backward compatibility, one field in the RAR UL grant may be repurposed to indicate the enabling/disabling transform precoding for Msg3 initial transmission. In this case, bit “1” may be used to indicate transform precoding is enabled, e.g., DFT-s-OFDM waveform is employed for the Msg3 initial transmission, while bit “0” may be used to indicate transform precoding is disabled, e.g., CP-OFDM waveform is employed for the Msg3 initial transmission.

Note that when Msg3 waveform is determined from dynamic enabling/disabling, transform precoding may override the waveform which is configured by msg3-transformPrecoder.

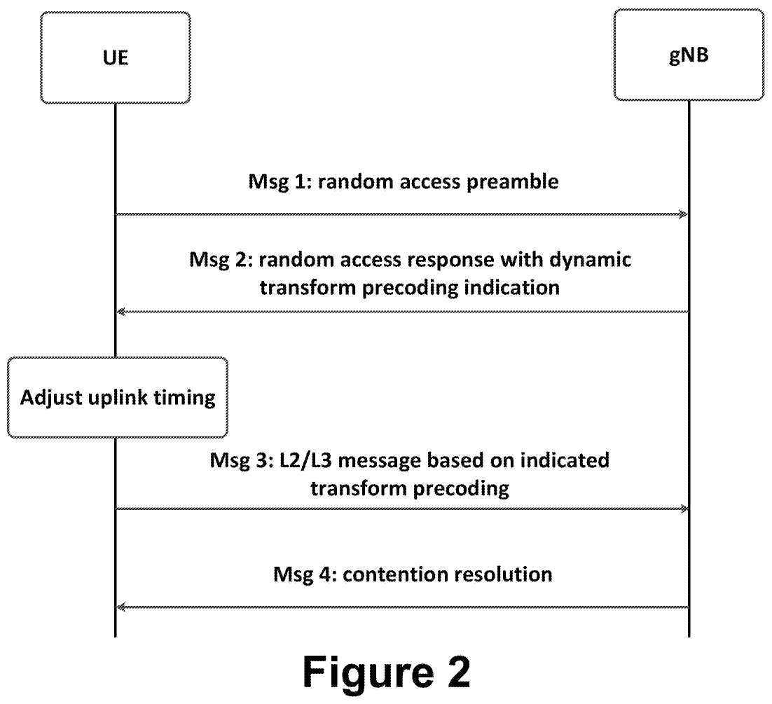

FIG. 2 illustrates one example of the random access procedure with dynamic transform precoding indication for Msg3 initial transmission. In the example, dynamic transform precoding indication is indicated in the RAR UL grant. Further, UE transmits Msg3 initial transmission in accordance with the indicated transform precoding indication.

In one option, one most significant bit (MSB) of TPC command for PUSCH can be repurposed for transform precoding indication. Further, 2 LSB of TPC command may be used to indicate 4 values of TPC command as defined in Table 8.2-2 in TS38.213, V. 17.0.0 [1]. Note that the 4 values of TPC command for PUSCH may be configured by higher layers via symbol information block (SIB) or NR remaining minimum system information (RMSI).

Table 1 illustrates one example of modified RAR UL grant to indicate enabling/disabling transform precoding. In the example, 1 MSB of TPC command for PUSCH is used to indicate transform precoding.

TABLE 1
Modified RAR UL grant to indicate enabling/disabling
transform precoding: Option 1

| RAR grant field | Number of bits |
|---|---|
| Frequency hopping flag | 1 |
| PUSCH frequency | 14, for operation without shared spectrum |
| resource allocation | channel access |
| | 12, for operation with shared spectrum |
| | channel access |
| PUSCH time resource | 4 |
| allocation | |
| MCS | 4 |
| TPC command for | 2 |
| PUSCH | |
| Transform precoder | 1 |
| CSI request | 1 |
| ChannelAccess-CPext | 0, for operation without shared spectrum |
| | channel access |
| | 2, for operation with shared spectrum |
| | channel access |

In another option, CSI request may be repurposed for transform precoding indication. Note that in NR, CSI request in RAR UL grant is reserved. In addition, whether to enable CSI request or transform precoding indication in the RAR UL grant may be configured by higher layers via RMSI.

Table 2 illustrates one example of modified RAR UL grant to indicate enabling/disabling transform precoding. In the example, CSI request field is disabled, and 1 bit transform precoding is included in the RAR UL grant.

TABLE 2
Modified RAR UL grant to indicate enabling/disabling
transform precoding: Option 2

| RAR grant field | Number of bits |
|---|---|
| Frequency hopping flag | 1 |
| PUSCH frequency | 14, for operation without shared spectrum |
| resource allocation | channel access |
| | 12, for operation with shared spectrum |
| | channel access |
| PUSCH time resource | 4 |
| allocation | |
| MCS | 4 |
| TPC command for | 3 |
| PUSCH | |
| Transform precoder | 1 |
| CSI request | 0 |
| ChannelAccess-CPext | 0, for operation without shared spectrum |
| | channel access |
| | 2, for operation with shared spectrum |
| | channel access |

In another option, 1 MSB of PUSCH frequency resource allocation can be repurposed for transform precoding indication. Table 3 illustrates one example of modified RAR UL grant to indicate enabling/disabling transform precoding. In the example, 1 bit transform precoding is included in the RAR UL grant, and 13 bits are used for PUSCH frequency resource allocation for operation without shared spectrum channel access

TABLE 3
Modified RAR UL grant to indicate enabling/disabling
transform precoding: Option 3

| RAR grant field | Number of bits |
|---|---|
| Frequency hopping flag | 1 |
| PUSCH frequency | 13, for operation without shared spectrum |
| resource allocation | channel access |
| | 12, for operation with shared spectrum |
| | channel access |
| PUSCH time resource | 4 |
| allocation | |
| MCS | 4 |
| TPC command for | 3 |
| PUSCH | |
| Transform precoder | 1 |
| CSI request | 1 |
| ChannelAccess-CPext | 0, for operation without shared spectrum |
| | channel access |
| | 2, for operation with shared spectrum |
| | channel access |

In another embodiment, enabling/disabling transform precoding may be indicated by PUSCH time resource allocation. In particular, a new TDRA table may be defined, where each row of the TDRA table may include enabling/disabling transform precoding, K2, mapping type, starting and length indicator value (SLIV). Note that K2, mapping type, and SLIV may be selected based on a row of TDRA table as defined in Section 6.1.2.1.1 in TS38.214, V17.0.0 [2].

For this option, based on the indicated PUSCH time resource allocation from RAR UL, UE can determine whether transform precoding is enabled/disabled or whether CP-OFDM or DFT-s-OFDM waveform is used for Msg3 transmission.

In another embodiment, one or more states in one or more field or reserved state in the RAR UL grant may be used to indicate enabling/disabling transform precoding for Msg3 initial transmission.

In another option, some state in one or more field or reserved state in the RAR UL grant may be used to indicate that the transform precoding which is configured by msg3-transformPrecoder is reverted. In one example, when lowest value for TPC command is indicated in the RAR UL grant, this would indicate that the transform precoding which is configured by msg3-transformPrecoder is reverted.

### Dynamic Transform Precoding Indication for Msg3 Retransmission

Aspects of various embodiments for dynamic transform precoding indication for Msg3 retransmission are described further below.

In one embodiment, enabling/disabling transform precoding for CP-OFDM and DFT-s-OFDM waveform generation of Msg3 retransmission can be explicitly indicated in the DCI format 0_0 with CRC scrambled by TC-RNTI.

As a further extension, whether this field is present in the DCI format 0_0 with CRC scrambled by TC-RNTI can be configured by higher layers via RMSI, OSI, or RRC signalling. In case when the field is not present, the UE shall, for this PUSCH transmission, consider the transform precoding either enabled or disabled according to the higher layer configured parameter msg3-transformPrecoder. Further, in case when the field is present, this transform precoding indication can override the msg3-transformPrecoder.

In another embodiment, the above embodiments for enabling/disabling transform precoding for Msg3 initial transmission can apply for that for Msg3 retransmission. For instance, a new TDRA table may be defined, where each row of the TDRA table may include enabling/disabling transform precoding, K2, mapping type and SLIV. Further, time domain resource assignment field in the DCI format 0_0 can be used to select one row of the new TDRA table. Further, UE can determine whether transform precoding is enabled/disabled or whether CP-OFDM or DFT-s-OFDM waveform is used for Msg3 retransmission.

In another option, “New data indicator” or “HARQ process number” fields which are reserved in the DCI format 0_0 with CRC scrambled by a TC-RNTI can be repurposed to indicate enabling/disabling transform precoding for Msg3 retransmission.

In another embodiment, in case of Msg3 PUSCH repetition for initial transmission and retransmission, e.g., the number of repetitions is greater than 1, a default transform precoding or waveform can be applied for Msg3 repetition. In particular, transform precoding may be enabled by default, e.g., waveform may be predefined in the specification as DFT-s-OFDM waveform.

Note that in this case, default waveform may override the dynamic waveform indication or waveform that is configured by msg3-transformPrecoder.

### Dynamic Transform Precoding Indication for PUSCH Transmission

Aspects of various embodiments for dynamic transform precoding indication for PUSCH transmission are described further below.

In one embodiment, for DCI format 0_0 with CRC scrambled by C-RNTI or CS-RNTI or MCS-C-RNTI, one bit field can be explicitly included to indicate enabling/disabling transform precoding for PUSCH transmission.

As a further extension, whether this field is present in the DCI format 0_0 with CRC scrambled by C-RNTI or CS-RNTI or MCS-C-RNTI can be configured by higher layers via RMSI, OSI, or RRC signalling. In case when the field is not present, the UE shall, for this PUSCH transmission, consider the transform precoding either enabled or disabled according to the higher layer configured parameter msg3-transformPrecoder. Further, in case when the field is present, this transform precoding indication can override the msg3-transformPrecoder.

Note that this option applies for PUSCH transmission scheduled by a PDCCH with CRC scrambled by CS-RNTI with NDI=1, C-RNTI, or MCS-CRNTI or SP-CSI-RNTI

In another embodiment, for DCI format 0_1 and 0_2 with CRC scrambled by C-RNTI or CS-RNTI or SP-CSI-RNTI or MCS-C-RNTI, one field can be explicitly included to indicate enabling/disabling transform precoding for PUSCH transmission.

As a further extension, whether this field is present in the DCI format 0_1 and 0_2 with CRC scrambled by C-RNTI or CS-RNTI or SP-CSI-RNTI or MCS-C-RNTI can be configured by higher layers via RMSI, OSI, or RRC signalling. In case when the field is not present, and if the UE is configured with the higher layer parameter transformPrecoder in pusch-Config, UE shall, for this PUSCH transmission, consider the transform precoding either enabled or disabled according to this parameter.

Further, in case when the field is not present, and if the UE is not configured with the higher layer parameter transformPrecoder in pusch-Config, the UE shall, for this PUSCH transmission, consider the transform precoding either enabled or disabled according to the higher layer configured parameter msg3-transformPrecoder.

When the field is present, this transform precoding indication can override the transformPrecoder in pusch-Config and/or msg3-transformPrecoder.

Note that this option applies for PUSCH transmission scheduled by a PDCCH with CRC scrambled by CS-RNTI with NDI=1, C-RNTI, or MCS-CRNTI or SP-CSI-RNTI.

In another embodiment, for the above embodiments, explicit indication in the RAR UL grant, DCI format 0_0, 0_1, or 0_2 may be used to indicate that the transform precoding which is configured by transformPrecoder in pusch-Config and/or msg3-transformPrecoder is reverted. For instance, when transformPrecoder enabled, the explicit indication in the DCI may be used to indicate that transformPrecoder disabled. The same mechanism can also apply for the case of Msg3 initial transmission and retransmission.

In another embodiment, a separate RNTI may be configured by higher layers via RRC signalling, and when DCI format 0_0, 0_1 and 0_2 with CRC scrambled with the separate RNTI, this may indicate that transform precoding which is configured by transformPrecoder in pusch-Config and/or msg3-transformPrecoder is reverted.

In another embodiment, for PUSCH repetition type A or type B when the number of repetitions is greater than 1, or for TBoMS when the number of slots for TBS determination is great than 1 regardless of whether repetitions is employed, transform precoding may be enabled by default, e.g., default waveform may be employed as DFT-s-OFDM waveform.

In another option, when SUL is triggered for PUSCH transmission, e.g., UL/SUL indicator is indicated as “1” in the DCI format 0_0, 0_1 or 0_2, transform precoding may be enabled by default, e.g., default waveform may be employed as DFT-s-OFDM waveform.

This may be combined with other conditions to determine whether default waveform is applied for PUSCH transmission. In one option, when the indicated modulation and coding scheme (MCS) is lower than a threshold, and/or when the indicated number of layers for the scheduled PUSCH is 1 or rank is 1, then this can be combined with the above option with more than one repetitions to determine that default waveform or DFT-s-OFDM waveform is applied for the PUSCH transmission. In this case, this may override the transformPrecoder in pusch-Config and/or msg3-transformPrecoder.

In another embodiment, one bit field may be included in the Medium Access Control-Control Element (MAC-CE) to indicate enabling/disabling transform precoding for PUSCH transmission.

In another option, one bit field may be included in the MAC-CE to indicate enabling/disabling transform precoding for PUSCH transmission for a bandwidth part (BWP) and/or uplink carrier. The bit field may be indicated together with BWP index and/or uplink CC index in the MAC-CE to indicate the transform precoding for PUSCH transmission for the indicated BWP and/or uplink carrier.

In another option, a bitmap is included in the MAC CE where each bit in the bitmap is used to indicate enabling/disabling transform precoding for PUSCH transmission for all the BWPs and/or CCs for the UE or a configured set of BWPs and/or CCs, the bit index in the bitmap is determined in an increasing order of BWP and/or CC index.

In some aspects, if a UE receives a MAC CE for enabling/disabling transform precoding for PUSCH transmission, the UE applies the enabled or disabled transform precoding in the first slot that is after slot k+3Nₛₗₒₜ^{subframe,μ} where k is the slot where the UE would transmit a PUCCH with HARQ-ACK information for the PDSCH providing the enabling/disabling transform precoding and μ is the SCS configuration for the PUCCH.

In one option, when a UE receives the MAC CE, the UE applies the enabled or disabled transform precoding for the PUSCH transmissions, which includes the PUSCH transmission scheduled by DCI format 0_0, 0_1, or 0_2, or by a PDCCH with CRC scrambled by C-RNTI or CS-RNTI or SP-CSI-RNTI or MCS-C-RNTI, or with CRC scrambled by CS-RNTI with NDI=1, C-RNTI, or MCS-CRNTI or SP-CSI-RNTI, or Type 1 configured grant based PUSCH (CG-PUSCH) or Type 2 CG-PUSCH after the activation. For this option, UE may ignore the higher layer configured parameter msg3-transformPrecoder and/or transformPrecoder in pusch-Config.

In another option, when a UE receives the MAC CE, the UE applies the enabled or disabled transform precoding for the PUSCH transmissions, which includes the PUSCH transmission scheduled by DCI format 0_1, or 0_2, or by a PDCCH with CRC scrambled by C-RNTI or CS-RNTI or SP-CSI-RNTI or MCS-C-RNTI, or with CRC scrambled by CS-RNTI with NDI=1, C-RNTI, or MCS-CRNTI or SP-CSI-RNTI. For this option, UE may ignore the higher layer configured parameter msg3-transformPrecoder and/or transformPrecoder in pusch-Config for the PUSCH scheduled by the above DCI format or PDCCH.

In another embodiment, when the UE would transmit a PUSCH corresponding to the DCI carrying indication for enabling/disabling transform precoding, the UE should apply enabled or disabled transform precoding for the PUSCH transmissions starting from the first slot that is at least N_{TP} symbols or slots after the last symbol of the PUSCH transmission. The first slot and the symbols are both determined on the active BWP with the smallest SCS among the active BWP(s) of the carrier(s) applying the enabled or disabled transform precoding.

In some aspects, N_{TP} can be configured by higher layers via RMSI, OSI, or RRC signalling or predefined in the specification.

In one option, when a UE receives the DCI carrying indication for enabling/disabling transform precoding, the UE applies the enabled or disabled transform precoding for the PUSCH transmissions, which includes the PUSCH transmission scheduled by DCI format 0_0, 0_1, or 0_2, or by a PDCCH with CRC scrambled by C-RNTI or CS-RNTI or SP-CSI-RNTI or MCS-C-RNTI, or with CRC scrambled by CS-RNTI with NDI=1, C-RNTI, or MCS-CRNTI or SP-CSI-RNTI, or Type 1 configured grant based PUSCH (CG-PUSCH) or Type 2 CG-PUSCH after the activation. For this option, UE may ignore the higher layer configured parameter msg3-transformPrecoder and/or transformPrecoder in pusch-Config.

In another option, when a UE receives the DCI carrying indication for enabling/disabling transform precoding, the UE applies the enabled or disabled transform precoding for the PUSCH transmissions, which includes the PUSCH transmission scheduled by DCI format 0_1, or 0_2, or by a PDCCH with CRC scrambled by C-RNTI or CS-RNTI or SP-CSI-RNTI or MCS-C-RNTI, or with CRC scrambled by CS-RNTI with NDI=1, C-RNTI, or MCS-CRNTI or SP-CSI-RNTI. For this option, UE may ignore the higher layer configured parameter msg3-transformPrecoder and/or transformPrecoder in pusch-Config for the PUSCH scheduled by the above DCI format or PDCCH.

In another embodiment, for DCI format 0_0 or 0_1/0_2 carrying the indication for enabling/disabling transform precoding, enabled or disabled transform precoding could be applied for the PUSCH transmission scheduled by the same DCI. When determining the size of some DCI fields, and if the size is different for CP-OFDM and DFT-s-OFDM, the field size is determined by the larger size among the two waveforms. If the waveform with smaller DCI size is enabled for the PUSCH transmission, zero padding is applied, i.e., bits of value ‘0’ are inserted to the field to match with the larger size. In one option, the DCI size is matched with the size assuming CP-OFDM waveform is applied.

The DCI fields where the size could be different for CP-OFDM and DFT-s-OFDM at least include the following:
Field of “Precoding information and number of layers”
Field of “Antenna ports”
Field of “PTRS-DMRS association”
Field of “SRS resource indicator (SRI)”
Field of “Second SRS resource indicator”
Field of “Second Precoding information”
Field of “Second PTRS-DMRS association”
Field of “DMRS sequence initialization”

In some aspects, if multiple codewords (e.g., two codewords) are indicated and/or configured for uplink transmission, e.g., for CP-OFDM with rank larger than 4, then some DCI field(s) used for the second codeword should be always present in the DCI, and these fields should be ignored by the UE if DFT-s-OFDM waveform is indicated by the DCI. In one option, the DCI field(s) used for the second codeword could include: Modulation and coding scheme for the second codeword (or the second transport block), New data indicator for the second codeword (or the second transport block), Redundancy version for the second codeword (or the second transport block).

In some aspects, if multiple codewords (e.g., two codewords) are indicated and/or configured for uplink transmission, default waveform is CP-OFDM waveform. In this case, the UE may ignore the bit field for dynamic waveform indication in the DCI.

In some aspects, for the DCI fields, PTRS-DMRS association and DMRS sequence initialization, when the UE determines DFT-s-OFDM waveform or transform precoding is enabled for the scheduled PUSCH(s), the UE ignores the above bit field.

In some aspects, in RRC configuration, two sets of RRC parameters could be configured to the UE, one for CP-OFDM and the other one for DFT-s-OFDM. For example, two sets of DMRS-UplinkConfig could be configured to the UE, one for the DMRS configuration with CP-OFDM, one for the DMRS configuration with DFT-s-OFDM.

In another embodiment, overall DCI size is determined in accordance with the maximum DCI size which is determined for CP-OFDM waveform and DFT-s-OFDM waveform. Further, waveform indication field may be included at the beginning of DCI format. In this case, DCI field size for each DCI field is determined in accordance with the indicated waveform type. In addition, zero padding is appended after all the DCI fields to match the maximum size determined from CP-OFDM waveform and DFT-s-OFDM waveform.

For this option, UE can determine the waveform in accordance with the indicated waveform type in the DCI format. Further, the UE can determine the corresponding DCI field size for the aforementioned DCI field based on the indicated waveform type.

In one example, waveform indication field may be included right after the carrier indicator field or prior to UL/SUL indicator field. Assuming the overall DCI size for CP-OFDM waveform is 60 bits, while the overall DCI size for DFT-s-OFDM waveform is 50 bits, and if the indicated waveform is DFT-s-OFDM waveform, zero padding is appended after all 50 bits for the DCI fields.

In another embodiment, for DCI format 0_0, or 0_1/0_2 without scheduling UL-SCH, or for DCI format 0_0, 0_1/0_2 without scheduling PUSCH but with SRS triggered, one field can be explicitly included to indicate enabling/disabling transform precoding for PUSCH transmission. Alternatively, without introducing new DCI field, some un-used field could be repurposed to indicate enabling/disabling transform precoding for PUSCH transmission. In one option, some specific field(s) value could be used for the validation of the DCI.

After successful reception of the DCI carrying the indication for enabling/disabling transform precoding, the UE should report ACK.

The enabling/disabling transform precoding should be applied for the subsequent PUSCH transmission after receiving the DCI. In one option, the enabling/disabling transform precoding could be applied for the subsequent PUSCH transmission after receiving the DCI until the next indication of enabling/disabling transform precoding is received.

The application time of enabling/disabling transform precoding could be introduced, after which the indicated waveform is applied for the PUSCH transmission. In one option, the application time is defined from the DCI until the UE starts to apply the indicated waveform for PUSCH transmission. In another option, the application time is defined from the UE sends ACK until the UE starts to apply the indicated waveform for PUSCH transmission.

For enabling/disabling transform precoding indicated by DCI format 0_0 or 0_1/0_2 without scheduling UL-SCH, or by DCI format 0_0 or 0_1/0_2 without scheduling PUSCH but with SRS triggered, the field size of DCI scheduling PUSCH transmission is determined by the applied waveform.

In another embodiment, for DCI format 1_0 or 1_1/1_2 without downlink assignment, one field can be explicitly included to indicate enabling/disabling transform precoding for PUSCH transmission. Alternatively, without introducing new DCI field, some un-used fields could be repurposed to indicate enabling/disabling transform precoding for PUSCH transmission. In one option, some specific field(s) value could be used for the validation of the DCI.

After successful reception of the DCI carrying the indication for enabling/disabling transform precoding, the UE should report ACK.

The enabling/disabling transform precoding should be applied for the subsequent PUSCH transmission after receiving the DCI. In one option, the enabling/disabling transform precoding could be applied for the subsequent PUSCH transmission after receiving the DCI until the next indication of enabling/disabling transform precoding is received.

The application time of enabling/disabling transform precoding could be introduced, after which the indicated waveform is applied for the PUSCH transmission. In one option, the application time is defined from the DCI until the UE starts to apply the indicated waveform for PUSCH transmission. In another option, the application time is defined from the UE sends ACK until the UE starts to apply the indicated waveform for PUSCH transmission.

For enabling/disabling transform precoding indicated by DCI format 1_0 or 1_1/1_2 without downlink assignment, the field size of DCI scheduling PUSCH transmission is determined by the applied waveform.

In another embodiment, when pusch-TimeDomainAllocationListForMultiPUSCH or pusch-TimeDomainAllocationListForMultiPUSCH-r17 is configured in pusch-Config, in one option, a single bit field is included in the DCI format, which indicates whether transform precoding is applied for all the scheduled PUSCH transmissions. In one example, when indicated time domain resource allocation (TDRA) includes more than one SLIVs or PUSCHs, the indicated waveform or enabling/disabling transform precoding can be applied for the more than one PUSCHs.

In another option, a single bit may be included in each row of pusch-TimeDomainAllocationListForMultiPUSCH or pusch-TimeDomainAllocationListForMultiPUSCH-r17, which is used to indicate whether transform precoding is applied for all the scheduled PUSCH transmissions.

In another option, separate indication on whether transform precoding is applied is included in each row of pusch-TimeDomainAllocationListForMultiPUSCH or pusch-TimeDomainAllocationListForMultiPUSCH-r17, together with separate starting and length indicator value (SLIV). In this case, this bit field is used to indicate whether transform precoding is applied in each scheduled PUSCH.

In another embodiment, for single DCI scheduling multi-slot PUSCH for multi-TRP operation, when two SRS resource sets are configured in srs-ResourceSetToAddModList or srs-ResourceSetToAddModListDCI-0-2 with higher layer parameter usage in SRS-ResourceSet set to ‘codebook’ or ‘noncodebook’, two bit fields on enabling/disabling transform precoding can be included in the DCI format, where the first and second bit fields are used to indicate whether transform precoding is applied for the scheduled PUSCHs targeting for the first TRP and second TRP, respectively.

In another option, for single DCI scheduling multi-slot PUSCH for multi-TRP operation, when two SRS resource sets are configured in srs-ResourceSetToAddModList or srs-ResourceSetToAddModListDCI-0-2 with higher layer parameter usage in SRS-ResourceSet set to ‘codebook’ or ‘noncodebook’, a single bit field is included in the DCI, which is used to indicate whether transform precoding is applied for the scheduled PUSCHs targeting for both the first TRP and second TRP.

In another embodiment, in case of multi-cell scheduling, where a DCI is used to schedule PUSCH transmissions in more than one cells, a single bit field is included in the DCI for multi-cell scheduling, which is used to indicate whether transform precoding is applied for the scheduled PUSCHs for the more than one carriers.

In some aspects, the single bit field is only applied for the carrier where dynamic waveform indication is configured or presence of dynamic waveform indication field in the DCI format 0_1 or 0_2 is configured by RRC signalling. In case when dynamic waveform indication is not configured or presence of dynamic waveform indication field in the DCI format 0_1 or 0_2 is not configured by RRC signalling for a carrier, the single bit field is not applied.

In another option, separate bit fields can be included in the DCI for multi-cell scheduling, where each bit field is used to indicate whether transform precoding is applied for the scheduled PUSCH in each carrier, respectively.

In some aspects, the size of waveform indication field can be determined in accordance with the maximum number of carriers among all rows of carrier indication table that is configured with dynamic waveform indication. In case when dynamic waveform indication is not configured or presence of dynamic waveform indication field in the DCI format 0_1 or 0_2 is not configured by RRC signalling for a carrier, waveform indication for the carrier is not included in the waveform indication field.

In one example, assuming 2 rows are configured for the carrier indication table, where first row is configured with {cell #0, cell #1} and second row is configured with {cell #0, cell #2}, for cell #0 and cell #1, dynamic waveform indication is configured while for cell #2, dynamic waveform indication is not configured, in this case, waveform indication field size is 2.

### Systems and Implementations

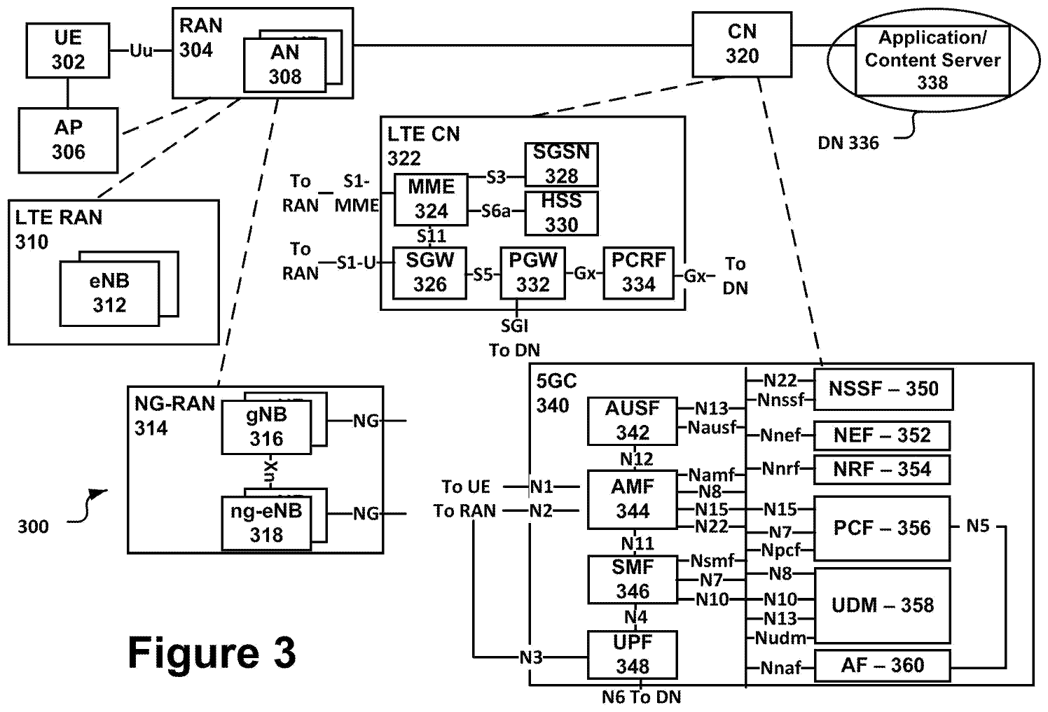

FIGS. 3-5 illustrate various systems, devices, and components that may implement aspects of disclosed embodiments.

FIG. 3 illustrates a network 300 in accordance with various embodiments. The network 300 may operate in a manner consistent with 3GPP technical specifications for LTE or 5G/NR systems. However, the example embodiments are not limited in this regard and the described embodiments may apply to other networks that benefit from the principles described herein, such as future 3GPP systems, or the like.

The network 300 may include a UE 302, which may include any mobile or non-mobile computing device designed to communicate with a RAN 304 via an over-the-air connection. The UE 302 may be communicatively coupled with the RAN 304 by a Uu interface. The UE 302 may be, but is not limited to, a smartphone, tablet computer, wearable computer device, desktop computer, laptop computer, in-vehicle infotainment, in-car entertainment device, instrument cluster, head-up display device, onboard diagnostic device, dashtop mobile equipment, mobile data terminal, electronic engine management system, electronic/engine control unit, electronic/engine control module, embedded system, sensor, microcontroller, control module, engine management system, networked appliance, machine-type communication device, M2M or D2D device, IoT device, etc.

In some embodiments, the network 300 may include a plurality of UEs coupled directly with one another via a sidelink interface. The UEs may be M2M/D2D devices that communicate using physical sidelink channels such as, but not limited to, PSBCH, PSDCH, PSSCH, PSCCH, PSFCH, etc.

In some embodiments, the UE 302 may additionally communicate with an AP 306 via an over-the-air connection. The AP 306 may manage a WLAN connection, which may serve to offload some/all network traffic from the RAN 304. The connection between the UE 302 and the AP 306 may be consistent with any IEEE 802.11 protocol, wherein the AP 306 could be a wireless fidelity (Wi-Fi®) router. In some embodiments, the UE 302, RAN 304, and AP 306 may utilize cellular-WLAN aggregation (for example, LWA/LWIP). Cellular-WLAN aggregation may involve the UE 302 being configured by the RAN 304 to utilize both cellular radio resources and WLAN resources.

The RAN 304 may include one or more access nodes, for example, AN 308. AN 308 may terminate air-interface protocols for the UE 302 by providing access stratum protocols including RRC, PDCP, RLC, MAC, and L1 protocols. In this manner, the AN 308 may enable data/voice connectivity between CN 320 and the UE 302. In some embodiments, the AN 308 may be implemented in a discrete device or as one or more software entities running on server computers as part of, for example, a virtual network, which may be referred to as a CRAN or virtual baseband unit pool. The AN 308 be referred to as a BS, gNB, RAN node, eNB, ng-eNB, NodeB, RSU, TRxP, TRP, etc. The AN 308 may be a macrocell base station or a low power base station for providing femtocells, picocells or other like cells having smaller coverage areas, smaller user capacity, or higher bandwidth compared to macrocells.

In embodiments in which the RAN 304 includes a plurality of ANs, they may be coupled with one another via an X2 interface (if the RAN 304 is an LTE RAN) or an Xn interface (if the RAN 304 is a 5G RAN). The X2/Xn interfaces, which may be separated into control/user plane interfaces in some embodiments, may allow the ANs to communicate information related to handovers, data/context transfers, mobility, load management, interference coordination, etc.

The ANs of the RAN 304 may each manage one or more cells, cell groups, component carriers, etc. to provide the UE 302 with an air interface for network access. The UE 302 may be simultaneously connected with a plurality of cells provided by the same or different ANs of the RAN 304. For example, the UE 302 and RAN 304 may use carrier aggregation to allow the UE 302 to connect with a plurality of component carriers, each corresponding to a Pcell or Scell. In dual connectivity scenarios, a first AN may be a master node that provides an MCG and a second AN may be secondary node that provides an SCG. The first/second ANs may be any combination of eNB, gNB, ng-eNB, etc.

The RAN 304 may provide the air interface over a licensed spectrum or an unlicensed spectrum. To operate in the unlicensed spectrum, the nodes may use LAA, eLAA, and/or feLAA mechanisms based on CA technology with PCells/Scells. Prior to accessing the unlicensed spectrum, the nodes may perform medium/carrier-sensing operations based on, for example, a listen-before-talk (LBT) protocol.

In V2X scenarios the UE 302 or AN 308 may be or act as a RSU, which may refer to any transportation infrastructure entity used for V2X communications. An RSU may be implemented in or by a suitable AN or a stationary (or relatively stationary) UE. An RSU implemented in or by: a UE may be referred to as a “UE-type RSU”; an eNB may be referred to as an “eNB-type RSU”; a gNB may be referred to as a “gNB-type RSU”; and the like. In one example, an RSU is a computing device coupled with radio frequency circuitry located on a roadside that provides connectivity support to passing vehicle UEs. The RSU may also include internal data storage circuitry to store intersection map geometry, traffic statistics, media, as well as applications/software to sense and control ongoing vehicular and pedestrian traffic. The RSU may provide very low latency communications required for high speed events, such as crash avoidance, traffic warnings, and the like. Additionally or alternatively, the RSU may provide other cellular/WLAN communications services. The components of the RSU may be packaged in a weatherproof enclosure suitable for outdoor installation, and may include a network interface controller to provide a wired connection (e.g., Ethernet) to a traffic signal controller or a backhaul network.

In some embodiments, the RAN 304 may be an LTE RAN 310 with eNBs, for example, eNB 312. The LTE RAN 310 may provide an LTE air interface with the following characteristics: SCS of 15 kHz; CP-OFDM waveform for DL and SC-FDMA waveform for UL; turbo codes for data and TBCC for control; etc. The LTE air interface may rely on CSI-RS for CSI acquisition and beam management; PDSCH/PDCCH DMRS for PDSCH/PDCCH demodulation; and CRS for cell search and initial acquisition, channel quality measurements, and channel estimation for coherent demodulation/detection at the UE. The LTE air interface may operating on sub-6 GHz bands.

In some embodiments, the RAN 304 may be an NG-RAN 314 with gNBs, for example, gNB 316, or ng-eNBs, for example, ng-eNB 318. The gNB 316 may connect with 5G-enabled UEs using a 5G NR interface. The gNB 316 may connect with a 5G core through an NG interface, which may include an N2 interface or an N3 interface. The ng-eNB 318 may also connect with the 5G core through an NG interface, but may connect with a UE via an LTE air interface. The gNB 316 and the ng-eNB 318 may connect with each other over an Xn interface.

In some embodiments, the NG interface may be split into two parts, an NG user plane (NG-U) interface, which carries traffic data between the nodes of the NG-RAN 314 and a UPF 348 (e.g., N3 interface), and an NG control plane (NG-C) interface, which is a signaling interface between the nodes of the NG-RAN 314 and an AMF 344 (e.g., N2 interface).

The NG-RAN 314 may provide a 5G-NR air interface with the following characteristics: variable SCS; CP-OFDM for DL, CP-OFDM and DFT-s-OFDM for UL; polar, repetition, simplex, and Reed-Muller codes for control and LDPC for data. The 5G-NR air interface may rely on CSI-RS, PDSCH/PDCCH DMRS similar to the LTE air interface. The 5G-NR air interface may not use a CRS, but may use PBCH DMRS for PBCH demodulation; PTRS for phase tracking for PDSCH; and tracking reference signal for time tracking. The 5G-NR air interface may operating on FR1 bands that include sub-6 GHz bands or FR2 bands that include bands from 24.25 GHz to 52.6 GHz. The 5G-NR air interface may include an SSB that is an area of a downlink resource grid that includes PSS/SSS/PBCH.

In some embodiments, the 5G-NR air interface may utilize BWPs for various purposes. For example, BWP can be used for dynamic adaptation of the SCS. For example, the UE 302 can be configured with multiple BWPs where each BWP configuration has a different SCS. When a BWP change is indicated to the UE 302, the SCS of the transmission is changed as well. Another use case example of BWP is related to power saving. In particular, multiple BWPs can be configured for the UE 302 with different amount of frequency resources (for example, PRBs) to support data transmission under different traffic loading scenarios. A BWP containing a smaller number of PRBs can be used for data transmission with small traffic load while allowing power saving at the UE 302 and in some cases at the gNB 316. A BWP containing a larger number of PRBs can be used for scenarios with higher traffic load.

The RAN 304 is communicatively coupled to CN 320 that includes network elements to provide various functions to support data and telecommunications services to customers/subscribers (for example, users of UE 302). The components of the CN 320 may be implemented in one physical node or separate physical nodes. In some embodiments, NFV may be utilized to virtualize any or all of the functions provided by the network elements of the CN 320 onto physical compute/storage resources in servers, switches, etc. A logical instantiation of the CN 320 may be referred to as a network slice, and a logical instantiation of a portion of the CN 320 may be referred to as a network sub-slice.

In some embodiments, the CN 320 may be an LTE CN 322, which may also be referred to as an EPC. The LTE CN 322 may include MME 324, SGW 326, SGSN 328, HSS 330, PGW 332, and PCRF 334 coupled with one another over interfaces (or “reference points”) as shown. Functions of the elements of the LTE CN 322 may be briefly introduced as follows.

The MME 324 may implement mobility management functions to track a current location of the UE 302 to facilitate paging, bearer activation/deactivation, handovers, gateway selection, authentication, etc.

The SGW 326 may terminate an Si interface toward the RAN and route data packets between the RAN and the LTE CN 322. The SGW 326 may be a local mobility anchor point for inter-RAN node handovers and also may provide an anchor for inter-3GPP mobility. Other responsibilities may include lawful intercept, charging, and some policy enforcement.

The SGSN 328 may track a location of the UE 302 and perform security functions and access control. In addition, the SGSN 328 may perform inter-EPC node signaling for mobility between different RAT networks; PDN and S-GW selection as specified by MME 324; MME selection for handovers; etc. The S3 reference point between the MME 324 and the SGSN 328 may enable user and bearer information exchange for inter-3GPP access network mobility in idle/active states.

The HSS 330 may include a database for network users, including subscription-related information to support the network entities' handling of communication sessions. The HSS 330 can provide support for routing/roaming, authentication, authorization, naming/addressing resolution, location dependencies, etc. An S6a reference point between the HSS 330 and the MME 324 may enable transfer of subscription and authentication data for authenticating/authorizing user access to the LTE CN 320.

The PGW 332 may terminate an SGi interface toward a data network (DN) 336 that may include an application/content server 338. The PGW 332 may route data packets between the LTE CN 322 and the data network 336. The PGW 332 may be coupled with the SGW 326 by an S5 reference point to facilitate user plane tunneling and tunnel management. The PGW 332 may further include a node for policy enforcement and charging data collection (for example, PCEF). Additionally, the SGi reference point between the PGW 332 and the data network 336 may be an operator external public, a private PDN, or an intra-operator packet data network, for example, for provision of IMS services. The PGW 332 may be coupled with a PCRF 334 via a Gx reference point.

The PCRF 334 is the policy and charging control element of the LTE CN 322. The PCRF 334 may be communicatively coupled to the app/content server 338 to determine appropriate QoS and charging parameters for service flows. The PCRF 332 may provision associated rules into a PCEF (via Gx reference point) with appropriate TFT and QCI.

In some embodiments, the CN 320 may be a 5GC 340. The 5GC 340 may include an AUSF 342, AMF 344, SMF 346, UPF 348, NSSF 350, NEF 352, NRF 354, PCF 356, UDM 358, and AF 360 coupled with one another over interfaces (or “reference points”) as shown. Functions of the elements of the 5GC 340 may be briefly introduced as follows.

The AUSF 342 may store data for authentication of UE 302 and handle authentication-related functionality. The AUSF 342 may facilitate a common authentication framework for various access types. In addition to communicating with other elements of the 5GC 340 over reference points as shown, the AUSF 342 may exhibit an Nausf service-based interface.

The AMF 344 may allow other functions of the 5GC 340 to communicate with the UE 302 and the RAN 304 and to subscribe to notifications about mobility events with respect to the UE 302. The AMF 344 may be responsible for registration management (for example, for registering UE 302), connection management, reachability management, mobility management, lawful interception of AMF-related events, and access authentication and authorization. The AMF 344 may provide transport for SM messages between the UE 302 and the SMF 346, and act as a transparent proxy for routing SM messages. AMF 344 may also provide transport for SMS messages between UE 302 and an SMSF. AMF 344 may interact with the AUSF 342 and the ULE 302 to perform various security anchor and context management functions. Furthermore, AMF 344 may be a termination point of a RAN CP interface, which may include or be an N2 reference point between the RAN 304 and the AMF 344; and the AMF 344 may be a termination point of NAS (N1) signaling, and perform NAS ciphering and integrity protection. AMF 344 may also support NAS signaling with the UE 302 over an N3 IWF interface.

The SMF 346 may be responsible for SM (for example, session establishment, tunnel management between UPF 348 and AN 308); UE IP address allocation and management (including optional authorization); selection and control of UP function; configuring traffic steering at UPF 348 to route traffic to proper destination; termination of interfaces toward policy control functions; controlling part of policy enforcement, charging, and QoS; lawful intercept (for SM events and interface to LI system); termination of SM parts of NAS messages; downlink data notification; initiating AN specific SM information, sent via AMF 344 over N2 to AN 308; and determining SSC mode of a session. SM may refer to management of a PDU session, and a PDU session or “session” may refer to a PDU connectivity service that provides or enables the exchange of PDUs between the UE 302 and the data network 336.

The UPF 348 may act as an anchor point for intra-RAT and inter-RAT mobility, an external PDU session point of interconnect to data network 336, and a branching point to support multi-homed PDU session. The UPF 348 may also perform packet routing and forwarding, perform packet inspection, enforce the user plane part of policy rules, lawfully intercept packets (UP collection), perform traffic usage reporting, perform QoS handling for a user plane (e.g., packet filtering, gating, UL/DL rate enforcement), perform uplink traffic verification (e.g., SDF-to-QoS flow mapping), transport level packet marking in the uplink and downlink, and perform downlink packet buffering and downlink data notification triggering. UPF 348 may include an uplink classifier to support routing traffic flows to a data network.

The NSSF 350 may select a set of network slice instances serving the UE 302. The NSSF 350 may also determine allowed NSSAI and the mapping to the subscribed S-NSSAIs, if needed. The NSSF 350 may also determine the AMF set to be used to serve the UE 302, or a list of candidate AMFs based on a suitable configuration and possibly by querying the NRF 354. The selection of a set of network slice instances for the UE 302 may be triggered by the AMF 344 with which the UE 302 is registered by interacting with the NSSF 350, which may lead to a change of AMF. The NSSF 350 may interact with the AMF 344 via an N22 reference point; and may communicate with another NSSF in a visited network via an N31 reference point (not shown). Additionally, the NSSF 350 may exhibit an Nnssf service-based interface.

The NEF 352 may securely expose services and capabilities provided by 3GPP network functions for third party, internal exposure/re-exposure, AFs (e.g., AF 360), edge computing or fog computing systems, etc. In such embodiments, the NEF 352 may authenticate, authorize, or throttle the AFs. NEF 352 may also translate information exchanged with the AF 360 and information exchanged with internal network functions. For example, the NEF 352 may translate between an AF-Service-Identifier and an internal 5GC information. NEF 352 may also receive information from other NFs based on exposed capabilities of other NFs. This information may be stored at the NEF 352 as structured data, or at a data storage NF using standardized interfaces. The stored information can then be re-exposed by the NEF 352 to other NFs and AFs, or used for other purposes such as analytics. Additionally, the NEF 352 may exhibit an Nnef service-based interface.

The NRF 354 may support service discovery functions, receive NF discovery requests from NF instances, and provide the information of the discovered NF instances to the NF instances. NRF 354 also maintains information of available NF instances and their supported services. As used herein, the terms “instantiate,” “instantiation,” and the like may refer to the creation of an instance, and an “instance” may refer to a concrete occurrence of an object, which may occur, for example, during execution of program code. Additionally, the NRF 354 may exhibit the Nnrf service-based interface.

The PCF 356 may provide policy rules to control plane functions to enforce them, and may also support unified policy framework to govern network behavior. The PCF 356 may also implement a front end to access subscription information relevant for policy decisions in a UDR of the UDM 358. In addition to communicating with functions over reference points as shown, the PCF 356 exhibit an Npcf service-based interface.

The UDM 358 may handle subscription-related information to support the network entities' handling of communication sessions, and may store subscription data of UE 302. For example, subscription data may be communicated via an N8 reference point between the UDM 358 and the AMF 344. The UDM 358 may include two parts, an application front end and a UDR. The UDR may store subscription data and policy data for the UDM 358 and the PCF 356, and/or structured data for exposure and application data (including PFDs for application detection, application request information for multiple UEs 302) for the NEF 352. The Nudr service-based interface may be exhibited by the UDR 221 to allow the UDM 358, PCF 356, and NEF 352 to access a particular set of the stored data, as well as to read, update (e.g., add, modify), delete, and subscribe to notification of relevant data changes in the UDR. The UDM may include a UDM-FE, which is in charge of processing credentials, location management, subscription management and so on. Several different front ends may serve the same user in different transactions. The UDM-FE accesses subscription information stored in the UDR and performs authentication credential processing, user identification handling, access authorization, registration/mobility management, and subscription management. In addition to communicating with other NFs over reference points as shown, the UDM 358 may exhibit the Nudm service-based interface.

The AF 360 may provide application influence on traffic routing, provide access to NEF, and interact with the policy framework for policy control.

In some embodiments, the 5GC 340 may enable edge computing by selecting operator/3^{rd} party services to be geographically close to a point that the UE 302 is attached to the network. This may reduce latency and load on the network. To provide edge-computing implementations, the 5GC 340 may select a UPF 348 close to the UE 302 and execute traffic steering from the UPF 348 to data network 336 via the N6 interface. This may be based on the UE subscription data, UE location, and information provided by the AF 360. In this way, the AF 360 may influence UPF (re)selection and traffic routing. Based on operator deployment, when AF 360 is considered to be a trusted entity, the network operator may permit AF 360 to interact directly with relevant NFs. Additionally, the AF 360 may exhibit an Naf service-based interface.

The data network 336 may represent various network operator services, Internet access, or third party services that may be provided by one or more servers including, for example, application/content server 338.

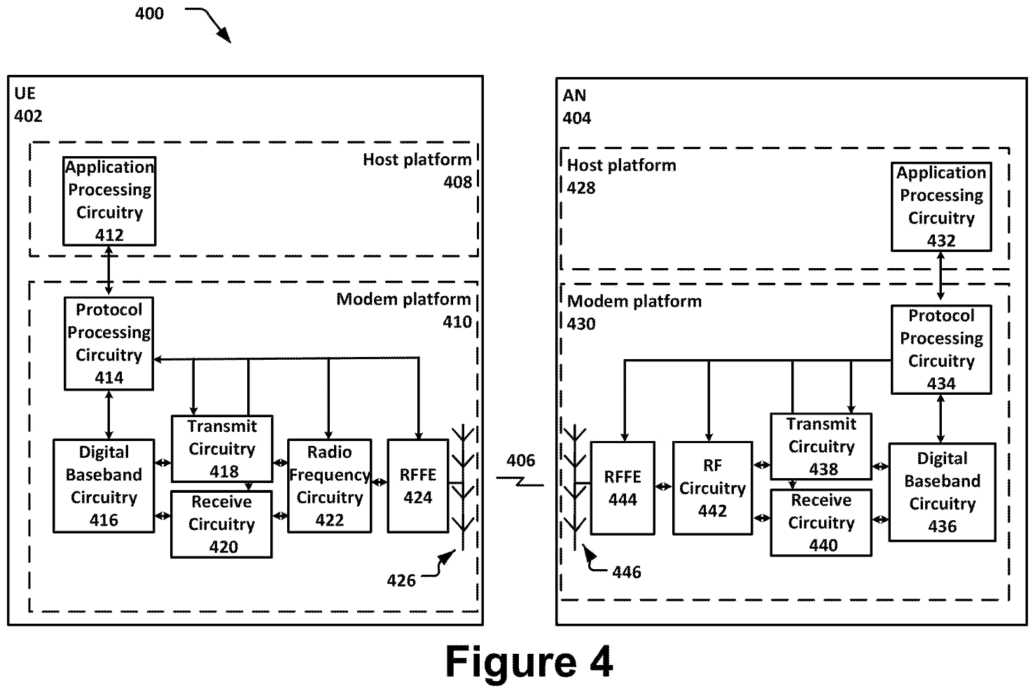

FIG. 4 schematically illustrates a wireless network 400 in accordance with various embodiments. The wireless network 400 may include a UE 402 in wireless communication with an AN 404. The UE 402 and AN 404 may be similar to, and substantially interchangeable with, like-named components described elsewhere herein.

The UE 402 may be communicatively coupled with the AN 404 via connection 406. The connection 406 is illustrated as an air interface to enable communicative coupling, and can be consistent with cellular communications protocols such as an LTE protocol or a 5G NR protocol operating at mmWave or sub-6 GHz frequencies.

The UE 402 may include a host platform 408 coupled with a modem platform 410. The host platform 408 may include application processing circuitry 412, which may be coupled with protocol processing circuitry 414 of the modem platform 410. The application processing circuitry 412 may run various applications for the UE 402 that source/sink application data. The application processing circuitry 412 may further implement one or more layer operations to transmit/receive application data to/from a data network. These layer operations may include transport (for example UDP) and Internet (for example, IP) operations

The protocol processing circuitry 414 may implement one or more of layer operations to facilitate transmission or reception of data over the connection 406. The layer operations implemented by the protocol processing circuitry 414 may include, for example, MAC, RLC, PDCP, RRC and NAS operations.

The modem platform 410 may further include digital baseband circuitry 416 that may implement one or more layer operations that are “below” layer operations performed by the protocol processing circuitry 414 in a network protocol stack. These operations may include, for example, PHY operations including one or more of HARQ-ACK functions, scrambling/descrambling, encoding/decoding, layer mapping/de-mapping, modulation symbol mapping, received symbol/bit metric determination, multi-antenna port precoding/decoding, which may include one or more of space-time, space-frequency or spatial coding, reference signal generation/detection, preamble sequence generation and/or decoding, synchronization sequence generation/detection, control channel signal blind decoding, and other related functions.

The modem platform 410 may further include transmit circuitry 418, receive circuitry 420, RF circuitry 422, and RF front end (RFFE) 424, which may include or connect to one or more antenna panels 426. Briefly, the transmit circuitry 418 may include a digital-to-analog converter, mixer, intermediate frequency (IF) components, etc.; the receive circuitry 420 may include an analog-to-digital converter, mixer, IF components, etc.; the RF circuitry 422 may include a low-noise amplifier, a power amplifier, power tracking components, etc.; RFFE 424 may include filters (for example, surface/bulk acoustic wave filters), switches, antenna tuners, beamforming components (for example, phase-array antenna components), etc. The selection and arrangement of the components of the transmit circuitry 418, receive circuitry 420, RF circuitry 422, RFFE 424, and antenna panels 426 (referred generically as “transmit/receive components”) may be specific to details of a specific implementation such as, for example, whether communication is TDM or FDM, in mmWave or sub-6 gHz frequencies, etc. In some embodiments, the transmit/receive components may be arranged in multiple parallel transmit/receive chains, may be disposed in the same or different chips/modules, etc.

In some embodiments, the protocol processing circuitry 414 may include one or more instances of control circuitry (not shown) to provide control functions for the transmit/receive components.

A UE reception may be established by and via the antenna panels 426, RFFE 424, RF circuitry 422, receive circuitry 420, digital baseband circuitry 416, and protocol processing circuitry 414. In some embodiments, the antenna panels 426 may receive a transmission from the AN 404 by receive-beamforming signals received by a plurality of antennas/antenna elements of the one or more antenna panels 426.

A UE transmission may be established by and via the protocol processing circuitry 414, digital baseband circuitry 416, transmit circuitry 418, RF circuitry 422, RFFE 424, and antenna panels 426. In some embodiments, the transmit components of the UE 404 may apply a spatial filter to the data to be transmitted to form a transmit beam emitted by the antenna elements of the antenna panels 426.

Similar to the UE 402, the AN 404 may include a host platform 428 coupled with a modem platform 430. The host platform 428 may include application processing circuitry 432 coupled with protocol processing circuitry 434 of the modem platform 430. The modem platform may further include digital baseband circuitry 436, transmit circuitry 438, receive circuitry 440, RF circuitry 442, RFFE circuitry 444, and antenna panels 446. The components of the AN 404 may be similar to and substantially interchangeable with like-named components of the UE 402. In addition to performing data transmission/reception as described above, the components of the AN 408 may perform various logical functions that include, for example, RNC functions such as radio bearer management, uplink and downlink dynamic radio resource management, and data packet scheduling.

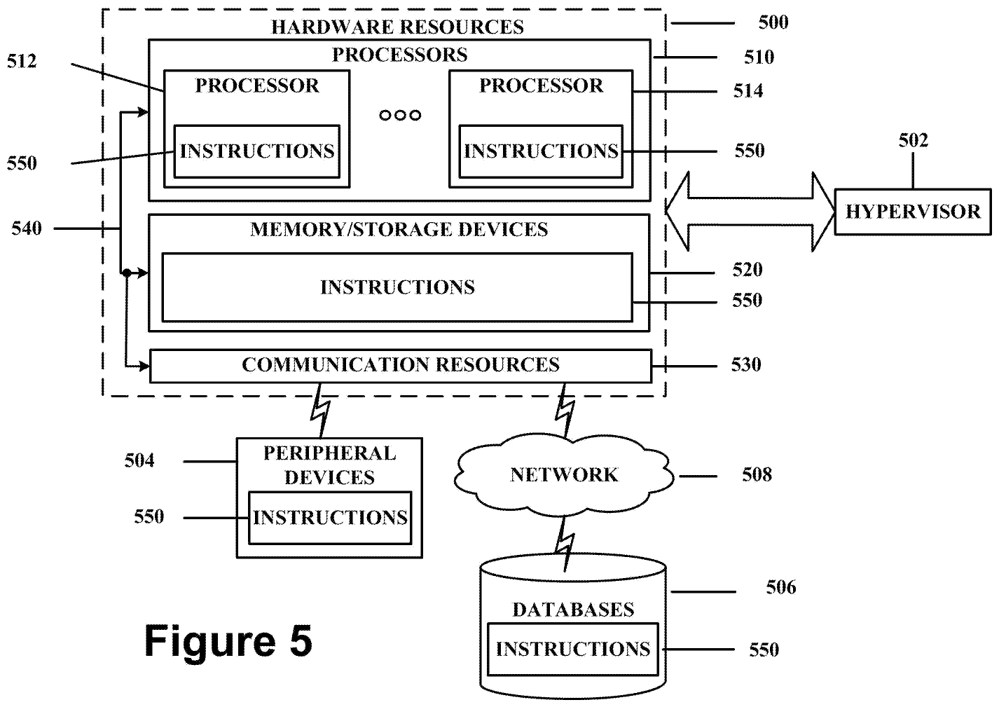

FIG. 5 is a block diagram illustrating components, according to some example embodiments, able to read instructions from a machine-readable or computer-readable medium (e.g., a non-transitory machine-readable storage medium) and perform any one or more of the methodologies discussed herein. Specifically, FIG. 5 shows a diagrammatic representation of hardware resources 500 including one or more processors (or processor cores) 510, one or more memory/storage devices 520, and one or more communication resources 530, each of which may be communicatively coupled via a bus 540 or other interface circuitry. For embodiments where node virtualization (e.g., NFV) is utilized, a hypervisor 502 may be executed to provide an execution environment for one or more network slices/sub-slices to utilize the hardware resources 500.

The processors 510 may include, for example, a processor 512 and a processor 514. The processors 510 may be, for example, a central processing unit (CPU), a reduced instruction set computing (RISC) processor, a complex instruction set computing (CISC) processor, a graphics processing unit (GPU), a DSP such as a baseband processor, an ASIC, an FPGA, a radio-frequency integrated circuit (RFIC), another processor (including those discussed herein), or any suitable combination thereof.

The memory/storage devices 520 may include main memory, disk storage, or any suitable combination thereof. The memory/storage devices 520 may include, but are not limited to, any type of volatile, non-volatile, or semi-volatile memory such as dynamic random access memory (DRAM), static random access memory (SRAM), erasable programmable read-only memory (EPROM), electrically erasable programmable read-only memory (EEPROM), Flash memory, solid-state storage, etc.

The communication resources 530 may include interconnection or network interface controllers, components, or other suitable devices to communicate with one or more peripheral devices 504 or one or more databases 506 or other network elements via a network 508. For example, the communication resources 530 may include wired communication components (e.g., for coupling via USB, Ethernet, etc.), cellular communication components, NFC components, Bluetooth® (or Bluetooth® Low Energy) components, Wi-Fi® components, and other communication components.

Instructions 550 may comprise software, a program, an application, an applet, an app, or other executable code for causing at least any of the processors 510 to perform any one or more of the methodologies discussed herein. The instructions 550 may reside, completely or partially, within at least one of the processors 510 (e.g., within the processor's cache memory), the memory/storage devices 520, or any suitable combination thereof. Furthermore, any portion of the instructions 550 may be transferred to the hardware resources 500 from any combination of the peripheral devices 504 or the databases 506. Accordingly, the memory of processors 510, the memory/storage devices 520, the peripheral devices 504, and the databases 506 are examples of computer-readable and machine-readable media.

### Example Procedures

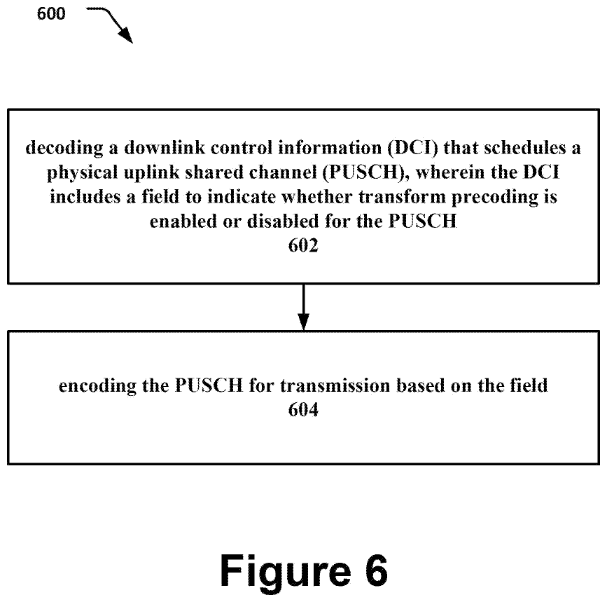

In some embodiments, the electronic device(s), network(s), system(s), chip(s) or component(s), or portions or implementations thereof, of FIGS. 3-5, or some other figure herein, may be configured to perform one or more processes, techniques, or methods as described herein, or portions thereof. One such process 600 is depicted in FIG. 6. In some embodiments, the process 600 may be performed by a UE or a portion thereof. At 602, the process 600 may include decoding a downlink control information (DCI) that schedules a physical uplink shared channel (PUSCH), wherein the DCI includes a field to indicate whether transform precoding is enabled or disabled for the PUSCH. At 604, the process 600 may further include encoding the PUSCH for transmission based on the field.

In some embodiments, the DCI is a DCI format 0_0, a DCI format 0_1, or a DCI format 0_2. Furthermore, in some embodiments, the DCI has a cyclic redundancy check (CRC) scrambled by a cell (C)-radio network temporary identifier (RNTI), a configured scheduling (CS)-RNTI, a semi-persistent-channel state information (SP-CSI)-RNTI, or a modulation and coding scheme (MCS)-C-RNTI.

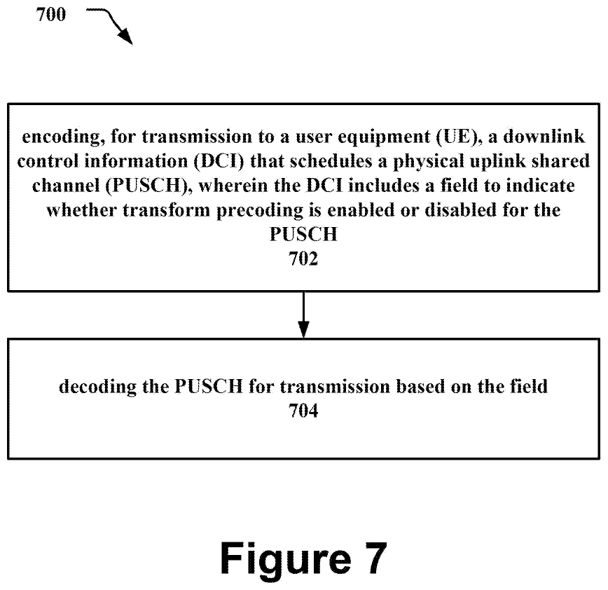

FIG. 7 illustrates another example process 700 in accordance with various embodiments. In some embodiments, the process 700 may be performed by a gNB or a portion thereof. At 702, the process 700 may include encoding, for transmission to a user equipment (UE), a downlink control information (DCI) that schedules a physical uplink shared channel (PUSCH), wherein the DCI includes a field to indicate whether transform precoding is enabled or disabled for the PUSCH. At 704, the process 700 may further include decoding the PUSCH based on the field.

In some embodiments, the DCI is a DCI format 0_0, a DCI format 0_1, or a DCI format 0_2. Furthermore, in some embodiments, the DCI has a cyclic redundancy check (CRC) scrambled by a cell (C)-radio network temporary identifier (RNTI), a configured scheduling (CS)-RNTI, a semi-persistent-channel state information (SP-CSI)-RNTI, or a modulation and coding scheme (MCS)-C-RNTI.

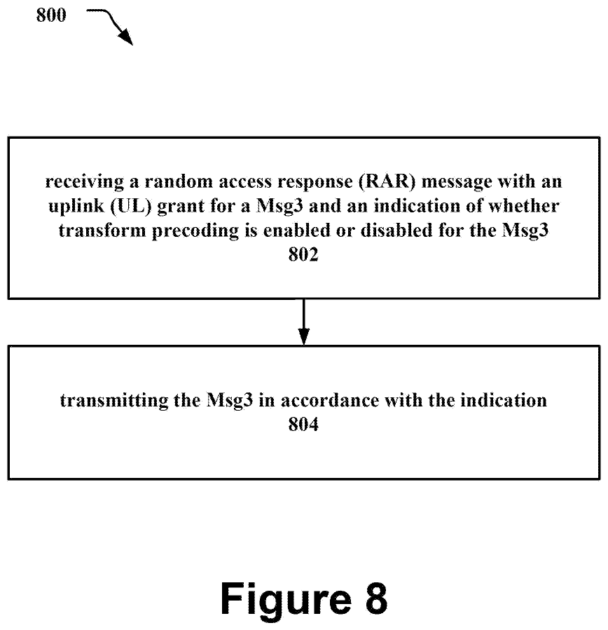

FIG. 8 illustrates another example process 800 in accordance with various embodiments. In some embodiments, the process 800 may be performed by a UE or a portion thereof. At 802, the process 800 may include receiving a random access response (RAR) message with an uplink (UL) grant for a Msg3 and an indication of whether transform precoding is enabled or disabled for the Msg3. In some embodiments, the indication may be in a designated field and/or may use one or more bits of a field that also encodes other information (e.g., by repurposing an existing field). At 804, the process 800 may further include transmitting the Msg3 in accordance with the indication.

For one or more embodiments, at least one of the components set forth in one or more of the preceding figures may be configured to perform one or more operations, techniques, processes, and/or methods as set forth in the example section below. For example, the baseband circuitry as described above in connection with one or more of the preceding figures may be configured to operate in accordance with one or more of the examples set forth below. For another example, circuitry associated with a UE, base station, network element, etc. as described above in connection with one or more of the preceding figures may be configured to operate in accordance with one or more of the examples set forth below in the example section.

### Examples

Some non-limiting examples of various embodiments are described further below.

Example A1 may include one or more non-transitory computer-readable media (NTCRM) having instructions, stored thereon, that when executed by one or more processors of a user equipment (UE) configure the UE to: decode a downlink control information (DCI) that schedules a physical uplink shared channel (PUSCH), wherein the DCI includes a field to indicate whether transform precoding is enabled or disabled for the PUSCH; and encode the PUSCH for transmission based on the field.

Example A2 may include the one or more NTCRM of example A1, wherein the DCI is a DCI format 0_0, a DCI format 0_1, or a DCI format 0_2.

Example A3 may include the one or more NTCRM of example A1, wherein the DCI has a cyclic redundancy check (CRC) scrambled by a cell (C)-radio network temporary identifier (RNTI), a configured scheduling (CS)-RNTI with a new data indicator having a value of 1, or a modulation and coding scheme (MCS)-C-RNTI.

Example A4 may include the one or more NTCRM of example A1, wherein the field is one bit.

Example A5 may include the one or more NTCRM of any one of examples A1-A4, wherein the instructions, when executed, are further to configure the UE to receive configuration information to indicate whether the field is to be present in the DCI.

Example A6 may include the one or more NTCRM of example A1, wherein the PUSCH is included in a Msg3 of a random access procedure.

Example A7 may include the one or more NTCRM of example A1, wherein the PUSCH is a first PUSCH, wherein the DCI schedules multiple PUSCHs in a cell including the first PUSCH, and wherein the field indicates whether transform precoding is enabled or disabled for all of the multiple PUSCHs.

Example A8 may include the one or more NTCRM of example A1, wherein the field is a first field, and wherein to decode the DCI includes to determine a size of a second field of the DCI as a larger of a first size that is used for a cyclic prefix (CP)-orthogonal frequency division multiplexing (OFDM) waveform and a second size that is used for a discrete Fourier transform (DFT)-spread (s)-OFDM waveform.

Example A9 may include the one or more NTCRM of example A1, wherein to decode the DCI includes to determine an overall size of the DCI as a larger of a first DCI size that is used for a cyclic prefix (CP)-orthogonal frequency division multiplexing (OFDM) waveform and a second DCI size that is used for a discrete Fourier transform (DFT)-spread (s)-OFDM waveform.

Example A10 may include the one or more NTCRM of example A9, wherein the field is at the beginning of the DCI to indicate whether the DCI corresponds to the CP-OFDM waveform or the DFT-s-OFDM waveform.

Example A11 may include one or more non-transitory computer-readable media (NTCRM) having instructions, stored thereon, that when executed by one or more processors of a next generation Node B (gNB) configure the gNB to: encode, for transmission to a user equipment (UE), a downlink control information (DCI) that schedules a physical uplink shared channel (PUSCH), wherein the DCI includes a field to indicate whether transform precoding is enabled or disabled for the PUSCH; and decode the PUSCH based on the field.

Example A12 may include the one or more NTCRM of example A11, wherein the DCI is a DCI format 0_0, a DCI format 0_1, or a DCI format 0_2.

Example A13 may include the one or more NTCRM of example A11, wherein the DCI has a cyclic redundancy check (CRC) scrambled by a cell (C)-radio network temporary identifier (RNTI), a configured scheduling (CS)-RNTI with a new data indicator having a value of 1, or a modulation and coding scheme (MCS)-C-RNTI.

Example A14 may include the one or more NTCRM of example A11, wherein the field is one bit.

Example A15 may include the one or more NTCRM of any one of examples A11-A14, wherein the instructions, when executed, are further to configure the gNB to transmit configuration information to the UE to indicate whether the field is to be present in the DCI.

Example A16 may include the one or more NTCRM of example A11, wherein the PUSCH is included in a Msg3 of a random access procedure.

Example A17 may include the one or more NTCRM of example A11, wherein the PUSCH is a first PUSCH, wherein the DCI schedules multiple PUSCHs in a cell including the first PUSCH, and wherein the field indicates whether transform precoding is enabled or disabled for all of the multiple PUSCHs.

Example A18 may include the one or more NTCRM of example A11, wherein the field is a first field, and wherein to encode the DCI includes to determine a size of a second field of the DCI as a larger of a first size that is used for a cyclic prefix (CP)-orthogonal frequency division multiplexing (OFDM) waveform and a second size that is used for a discrete Fourier transform (DFT)-spread (s)-OFDM waveform.

Example A19 may include the one or more NTCRM of example A11, wherein to encode the DCI includes to determine an overall size of the DCI as a larger of a first DCI size that is used for a cyclic prefix (CP)-orthogonal frequency division multiplexing (OFDM) waveform and a second DCI size that is used for a discrete Fourier transform (DFT)-spread (s)-OFDM waveform.

Example A20 may include the one or more NTCRM of example A19, wherein the DCI includes a waveform indication field at the beginning of the DCI to indicate whether the DCI corresponds to the CP-OFDM waveform or the DFT-s-OFDM waveform.

Example A21 may include one or more non-transitory computer-readable media (NTCRM) having instructions, stored thereon, that when executed by one or more processors of a user equipment (UE) configure the UE to: receive a random access response (RAR) message with an uplink (UL) grant for a Msg3 and an indication of whether transform precoding is enabled or disabled for the Msg3; and transmit the Msg3 in accordance with the indication.

Example A22 may include the one or more NTCRM of example A21, wherein the indication is provided by a bit of a designated field or a bit of a field that also encodes other information.

Example A23 may include the one or more NTCRM of example A22, wherein the field is a transmit power control (TPC) command field, a channel state information (CSI) request field, a physical uplink shared channel (PUSCH) frequency resource allocation field, or a PUSCH time resource allocation field.

Example A24 may include the one or more NTCRM of example A21, wherein the indication is based on a time domain resource allocation (TDRA) table, wherein individual rows of the TDRA table include the indication of whether transform precoding is enabled or disabled, a K2 value, a mapping type, and a starting and length indicator value (SLIV).

Example A25 may include the one or more NTCRM of any one of examples A21-A24, wherein the Msg3 is transmitted using a cyclic prefix (CP)-orthogonal frequency division multiplexing (OFDM) waveform or a discrete Fourier transform (DFT)-spread (s)-OFDM waveform based on the indication.

Example B1 may include a method of wireless communication for a fifth generation (5G) or new radio (NR) system, the method including:
receiving, by a UE from a gNB, a transform precoding indication in a random access response (RAR) uplink grant for Msg3 initial transmission; and
transmitting, by the UE, Msg3 initial transmission in accordance with the indicated transform precoding indication.

Example B2 may include the method of Example B1 or some other example herein, wherein enabling/disabling transform precoding for CP-OFDM and DFT-s-OFDM waveform generation can be indicated in the RAR UL grant for Msg3 initial transmission.

Example B3 may include the method of Example B1 or some other example herein, wherein one most significant bit (MSB) of transmit power control (TPC) command for PUSCH can be repurposed for transform precoding indication.

Example B4 may include the method of Example B1 or some other example herein, wherein CSI request may be repurposed for transform precoding indication, wherein whether to enable CSI request or transform precoding indication in the RAR UL grant may be configured by higher layers via RMSI.

Example B5 may include the method of Example B1 or some other example herein, wherein 1 MSB of PUSCH frequency resource allocation can be repurposed for transform precoding indication.

Example B6 may include the method of Example B1 or some other example herein, wherein enabling/disabling transform precoding may be indicated by PUSCH time resource allocation.

Example B7 may include the method of Example B6 or some other example herein, wherein a new TDRA table may be defined, where each row of the TDRA table may include enabling/disabling transform precoding, K2, mapping type, starting and length indicator value (SLIV).

Example B8 may include the method of Example B1 or some other example herein, wherein one or more states in one or more field or reserved state in the RAR UL grant may be used to indicate enabling/disabling transform precoding for Msg3 initial transmission.

Example B9 may include the method of Example B1 or some other example herein, wherein enabling/disabling transform precoding for CP-OFDM and DFT-s-OFDM waveform generation of Msg3 retransmission can be explicitly indicated in the DCI format 0_0 with CRC scrambled by TC-RNTI.

Example B10 may include the method of Example B1 or some other example herein, wherein the above embodiments for enabling/disabling transform precoding for Msg3 initial transmission can apply for that for Msg3 retransmission.

Example B11 may include the method of Example B1 or some other example herein, wherein “New data indicator” or “HARQ process number” fields which are reserved in the DCI format 0_0 with CRC scrambled by a TC-RNTI can be repurposed to indicate enabling/disabling transform precoding for Msg3 retransmission.

Example B12 may include the method of Example B1 or some other example herein, wherein in case of Msg3 PUSCH repetition for initial transmission and retransmission, e.g., the number of repetitions is greater than 1, a default transform precoding or waveform can be applied for Msg3 repetition.

Example B13 may include the method of Example B1 or some other example herein, wherein for DCI format 0_0 with CRC scrambled by C-RNTI or CS-RNTI or MCS-C-RNTI, one bit field can be explicitly included to indicate enabling/disabling transform precoding for PUSCH transmission.

Example B14 may include the method of Example B13 or some other example herein, wherein whether this field is present in the DCI format 0_0 with CRC scrambled by C-RNTI or CS-RNTI or MCS-C-RNTI can be configured by higher layers via RMSI, OSI, or RRC signalling.

Example B15 may include the method of Example B1 or some other example herein, wherein for DCI format 0_1 and 0_2 with CRC scrambled by C-RNTI or CS-RNTI or SP-CSI-RNTI or MCS-C-RNTI, one field can be explicitly included to indicate enabling/disabling transform precoding for PUSCH transmission.

Example B16 may include the method of Example B15 or some other example herein, wherein whether this field is present in the DCI format 0_1 and 0_2 with CRC scrambled by C-RNTI or CS-RNTI or SP-CSI-RNTI or MCS-C-RNTI can be configured by higher layers via RMSI, OSI, or RRC signalling.

Example B17 may include the method of Example B1 or some other example herein, wherein explicit indication in the RAR UL grant, DCI format 0_0, 0_1, or 0_2 may be used to indicate that the transform precoding which is configured by transformPrecoder in pusch-Config and/or msg3-transformPrecoder is reverted.

Example B18 may include the method of Example B1 or some other example herein, wherein a separate RNTI may be configured by higher layers via RRC signalling, and when DCI format 0_0, 0_1 and 0_2 with CRC scrambled with the separate RNTI, this may indicate that transform precoding which is configured by transformPrecoder in pusch-Config and/or msg3-transformPrecoder is reverted.

Example B19 may include the method of Example B1 or some other example herein, wherein for PUSCH repetition type A or type B when the number of repetitions is greater than 1, or for TBoMS when the number of slots for TBS determination is great than 1 regardless of whether repetitions is employed, transform precoding may be enabled by default, e.g., default waveform may be employed as DFT-s-OFDM waveform.

Example B20 may include the method of Example B1 or some other example herein, wherein when SUL is triggered for PUSCH transmission, e.g., UL/SUL indicator is indicated as “1” in the DCI format 0_0, 0_1 or 0_2, transform precoding may be enabled by default, e.g., default waveform may be employed as DFT-s-OFDM waveform.

Example B21 may include the method of Example B1 or some other example herein, wherein one bit field may be included in the MAC-CE to indicate enabling/disabling transform precoding for PUSCH transmission for a bandwidth part (BWP) and/or uplink carrier, wherein the bit field may be indicated together with BWP index and/or uplink CC index in the MAC-CE to indicate the transform precoding for PUSCH transmission for the indicated BWP and/or uplink carrier.

Example B22 may include the method of Example B1 or some other example herein, wherein if a UE receives a MAC CE for enabling/disabling transform precoding for PUSCH transmission, the UE applies the enabled or disabled transform precoding in the first slot that is after slot k+3Nₛₗₒₜ^{subframe,μ} where k is the slot where the UE would transmit a PUCCH with HARQ-ACK information for the PDSCH providing the enabling/disabling transform precoding and μ is the SCS configuration for the PUCCH.

Example B23 may include the method of Example B1 or some other example herein, wherein a UE receives the MAC CE, the UE applies the enabled or disabled transform precoding for the PUSCH transmissions, which includes the PUSCH transmission scheduled by DCI format 0_0, 0_1, or 0_2, or by a PDCCH with CRC scrambled by C-RNTI or CS-RNTI or SP-CSI-RNTI or MCS-C-RNTI, or with CRC scrambled by CS-RNTI with NDI=1, C-RNTI, or MCS-CRNTI or SP-CSI-RNTI, or Type 1 configured grant based PUSCH (CG-PUSCH) or Type 2 CG-PUSCH after the activation.

Example B24 may include the method of Example B1 or some other example herein, wherein when a UE receives the MAC CE, the UE applies the enabled or disabled transform precoding for the PUSCH transmissions, which includes the PUSCH transmission scheduled by DCI format 0_1, or 0_2, or by a PDCCH with CRC scrambled by C-RNTI or CS-RNTI or SP-CSI-RNTI or MCS-C-RNTI, or with CRC scrambled by CS-RNTI with NDI=1, C-RNTI, or MCS-CRNTI or SP-CSI-RNTI.

Example B25 may include the method of Example B1 or some other example herein, wherein when the UE would transmit a PUSCH corresponding to the DCI carrying indication for enabling/disabling transform precoding, the UE should apply enabled or disabled transform precoding for the PUSCH transmissions starting from the first slot that is at least N_TP symbols or slots after the last symbol of the PUSCH transmission. The first slot and the symbols are both determined on the active BWP with the smallest SCS among the active BWP(s) of the carrier(s) applying the enabled or disabled transform precoding.

Example B26 may include the method of Example B1 or some other example herein, wherein when determining the size of some DCI fields, and if the size is different for CP-OFDM and DFT-s-OFDM, the field size is determined by the larger size among the two waveforms.

Example B27 may include the method of Example B1 or some other example herein, wherein for DCI format 0_0, or 0_1/0_2 without scheduling UL-SCH, or for DCI format 0_0, 0_1/0_2 without scheduling PUSCH but with SRS triggered, one field can be explicitly included to indicate enabling/disabling transform precoding for PUSCH transmission

Example B28 may include the method of Example B1 or some other example herein, wherein for DCI format 1_0 or 1_1/1_2 without downlink assignment, one field can be explicitly included to indicate enabling/disabling transform precoding for PUSCH transmission

Example B29 may include the method of Example B1 or some other example herein, wherein the DCI size is matched with the size assuming CP-OFDM waveform is applied.

Example B30 may include the method of Example B1 or some other example herein, wherein when pusch-TimeDomainAllocationListForMultiPUSCH or pusch-TimeDomainAllocationListForMultiPUSCH-r17 is configured in pusch-Config, in one option, a single bit field is included in the DCI format, which indicates whether transform precoding is applied for all the scheduled PUSCH transmissions.

Example B31 may include the method of Example B1 or some other example herein, wherein for single DCI scheduling multi-slot PUSCH for multi-TRP operation, when two SRS resource sets are configured in srs-ResourceSetToAddModList or srs-ResourceSetToAddModListDCI-0-2 with higher layer parameter usage in SRS-ResourceSet set to ‘codebook’ or ‘noncodebook’, two bit fields on enabling/disabling transform precoding can be included in the DCI format, where the first and second bit fields are used to indicate whether transform precoding is applied for the scheduled PUSCHs targeting for the first TRP and second TRP, respectively.

Example B32 may include in some aspects, the size of waveform indication field can be determined in accordance with the maximum number of carriers among all rows of carrier indication table that is configured with dynamic waveform indication. In case when dynamic waveform indication is not configured or presence of dynamic waveform indication field in the DCI format 0_1 or 0_2 is not configured by RRC signalling for a carrier, waveform indication for the carrier is not included in the waveform indication field.

Example B33 may include one example, assuming 2 rows are configured for the carrier indication table, where first row is configured with {cell #0, cell #1} and second row is configured with {cell #0, cell #2}, for cell #0 and cell #1, dynamic waveform indication is configured while for cell #2, dynamic waveform indication is not configured, in this case, waveform indication field size is 2.

Example B34 may include a method of a user equipment (UE), the method comprising:
receiving a random access response (RAR) message with an uplink (UL) grant and an indication of transform precoding; and
transmitting a Msg3 in accordance with the indicated transform precoding.

Example B35 may include the method of Example B34 or some other example herein, wherein the indication enables or disables transform precoding for waveform generation for the Msg3.

Example B36 may include the method of Example B35 or some other example herein, wherein the Msg3 is transmitted using a CP-OFDM or DFT-s-OFDM waveform.

Example B37 may include the method of Example B34-36 or some other example herein, wherein the indication corresponds to a bit (e.g., a most significant bit (MSB)) of a transmit power control (TPC) command for a physical uplink shared channel (PUSCH).

Example B38 may include the method of Example B34-36 or some other example herein, wherein the indication corresponds to a CSI request field of the RAR message.

Example B39 may include the method of Example B38 or some other example herein, further comprising receiving configuration information to indicate whether the CSI request field is to be used for transform precoding indication.

Example B40 may include the method of Example B33-36 or some other example herein, wherein the indication corresponds to a bit (e.g., a MSB) of a PUSCH frequency resource allocation.

Example B41 may include the method of Example B34-36 or some other example herein, wherein the indication corresponds to a PUSCH time resource allocation.

Example B42 may include the method of Example B41 or some other example herein, wherein the indication is based on a time domain resource allocation (TDRA) table, wherein individual rows of the TDRA table include the indication of whether transform precoding is enabled or disabled, K2, mapping type, and starting and length indicator value (SLIV).

Example B43 may include the method of Example B34-42 or some other example herein, wherein the indication is included in a DCI format 0_0 with CRC scrambled by a temporary cell radio network temporary identifier (TC-RNTI).

Example B44 may include the method of Example B34-43 or some other example herein, wherein the Msg3 transmission is an initial transmission.

Example B45 may include the method of Example B34-43 or some other example herein, wherein the Msg3 transmission is a re-transmission.

Example B46 may include the method of Example B34-45 or some other example herein, further comprising receiving a DCI that enables or disables transform precoding for a PUSCH; and
transmitting the PUSCH based on the DCI.

Example B47 may include the method of Example B46 or some other example herein, wherein the DCI is a DCI format 0_0, a DCI format 0_1, or a DCI format 0_2.

Example B48 may include the method of Example B46 or some other example herein, wherein the DCI has a CRC scrambled by C-RNTI, CS-RNTI, SP-CSI-RNTI, or MCS-C-RNTI.

Example B49 may include the method of Example B47-48 or some other example herein, wherein the DCI includes a one bit field to enable or disable transform precoding.

Example B50a may include the method of Example B49 or some other example herein, further comprising receiving configuration information to indicate whether the one bit field is to be present in the DCI.

Example B50b may include the method of Example B34-50a or some other example herein, wherein the DCI is included in a Msg4 of a random access procedure.

Example B50c may include the method of Example B34-50a or some other example herein, wherein the PUSCH is included in the Msg3.

Example B50d may include the method of Example B46-50c or some other example herein, wherein the DCI size is matched assuming CP-OFDM waveform is applied.

Example B50e may include the method of Example B46-50d or some other example herein, wherein when pusch-TimeDomainAllocationListForMultiPUSCH or pusch-TimeDomainAllocationListForMultiPUSCH-r17 is configured in pusch-Config, the DCI includes a single bit field to indicate whether transform precoding is applied for all scheduled PUSCH transmissions.

Example B50f may include the method of Example B34-50e or some other example herein, wherein two SRS resource sets are configured with a usage of ‘codebook’ or ‘noncodebook’, and wherein the method further comprises receiving a single DCI to schedule a multi-slot PUSCH for multi-TRP operation, wherein the DCI includes two or more bit fields to indicate whether transform precoding is applied for scheduled PUSCHs targeting respective TRPs.

Example B50g may include the method of Example B34-50f, in some aspects, the size of waveform indication field can be determined in accordance with the maximum number of carriers among all rows of carrier indication table that is configured with dynamic waveform indication. In case when dynamic waveform indication is not configured or presence of dynamic waveform indication field in the DCI format 0_1 or 0_2 is not configured by RRC signalling for a carrier, waveform indication for the carrier is not included in the waveform indication field.

Example B50h may include the method of Example B34-50g, wherein, assuming 2 rows are configured for the carrier indication table, where first row is configured with {cell #0, cell #1} and second row is configured with {cell #0, cell #2}, for cell #0 and cell #1, dynamic waveform indication is configured while for cell #2, dynamic waveform indication is not configured, in this case, waveform indication field size is 2.

Example B51 may include a method of a next generation Node B (gNB), the method comprising:
transmitting, to a user equipment, a random access response (RAR) message with an uplink (UL) grant and an indication of transform precoding; and
receiving a Msg3 from the UE in accordance with the indicated transform precoding.

Example B52 may include the method of Example B51 or some other example herein, wherein the indication enables or disables transform precoding for waveform generation for the Msg3.

Example B53 may include the method of Example B52 or some other example herein, wherein the Msg3 is transmitted using a CP-OFDM or DFT-s-OFDM waveform.

Example B54 may include the method of Example B51-53 or some other example herein, wherein the indication corresponds to a bit (e.g., a most significant bit (MSB)) of a transmit power control (TPC) command for a physical uplink shared channel (PUSCH).

Example B55 may include the method of Example B51-53 or some other example herein, wherein the indication corresponds to a CSI request field of the RAR message.

Example B56 may include the method of Example B55 or some other example herein, further comprising transmitting, to the UE, configuration information to indicate whether the CSI request field is to be used for transform precoding indication.

Example B57 may include the method of Example B51-56 or some other example herein, wherein the indication corresponds to a bit (e.g., a MSB) of a PUSCH frequency resource allocation.

Example B58 may include the method of Example B51-57 or some other example herein, wherein the indication corresponds to a PUSCH time resource allocation.

Example B59 may include the method of Example B58 or some other example herein, wherein the indication is based on a time domain resource allocation (TDRA) table, wherein individual rows of the TDRA table include the indication of whether transform precoding is enabled or disabled, K2, mapping type, and starting and length indicator value (SLIV).

Example B60 may include the method of Example B51-59 or some other example herein, wherein the indication is included in a DCI format 0_0 with CRC scrambled by a temporary cell radio network temporary identifier (TC-RNTI).

Example B61 may include the method of Example B51-60 or some other example herein, wherein the Msg3 transmission is an initial transmission.

Example B62 may include the method of Example B51-60 or some other example herein, wherein the Msg3 transmission is a re-transmission.

Example B63 may include the method of Example B51-62 or some other example herein, further comprising transmitting a DCI that enables or disables transform precoding for a PUSCH; and receiving the PUSCH according to the DCI.

Example B64 may include the method of Example B63 or some other example herein, wherein the DCI is a DCI format 0_0, a DCI format 0_1, or a DCI format 0_2.

Example B65 may include the method of Example B64 or some other example herein, wherein the DCI has a CRC scrambled by C-RNTI, CS-RNTI, SP-CSI-RNTI, or MCS-C-RNTI.

Example B66 may include the method of Example B63-64 or some other example herein, wherein the DCI includes a one bit field to enable or disable transform precoding.

Example B67 may include the method of Example B66 or some other example herein, further comprising receiving configuration information to indicate whether the one bit field is to be present in the DCI.

Example B68 may include the method of Example B62-67 or some other example herein, wherein the DCI is included in a Msg4 of a random access procedure.

Example B69 may include the method of Example B62-67 or some other example herein, wherein the PUSCH is included in the Msg3.

Example B70 may include a method of a UE, the method comprising:
receiving a DCI that includes an indication of supplementary uplink (SUL) for PUSCH transmission; and
transmitting the PUSCH using transform precoding based on the indication.

Example B71 may include the method of Example B68, wherein the DCI has a DCI format 0_0, 0_1 or 0_2.

Example B72 may include a method of a UE, the method comprising:
receiving a MAC-CE that indicates whether transform precoding is enabled or disabled for a PUSCH; and
transmitting the PUSCH based on the indication.

Example B73 may include the method of Example B72 or some other example herein, wherein the indication corresponds to a bandwidth part (BWP) and/or an uplink carrier.

Example B74 may include the method of Example B73 or some other example herein, wherein the indication includes a BWP index and/or an uplink CC index for the corresponding BWP and/or uplink carrier.

Example B75 may include the method of Example B72-74 or some other example herein, wherein the transmitting further comprises applying the enabled or disabled transform precoding in the first slot that is after slot k+3Nₛₗₒₜ^{subframe,μ} where k is the slot where the UE would transmit a PUCCH with HARQ-ACK information for the PDSCH providing the enabling/disabling transform precoding and μ is the SCS configuration for the PUCCH.

Example B76 may include the method of Example B72-74 or some other example herein, wherein the PUSCH is scheduled by DCI format 0_0, 0_1, or 0_2, or by a PDCCH with CRC scrambled by C-RNTI or CS-RNTI or SP-CSI-RNTI or MCS-C-RNTI, or with CRC scrambled by CS-RNTI with NDI=1, C-RNTI, or MCS-CRNTI or SP-CSI-RNTI, or Type 1 configured grant based PUSCH (CG-PUSCH) or Type 2 CG-PUSCH after the activation.

Example B77 may include the method of Example B72-74 or some other example herein, wherein the PUSCH is scheduled by DCI format 0_1, or 0_2, or by a PDCCH with CRC scrambled by C-RNTI or CS-RNTI or SP-CSI-RNTI or MCS-C-RNTI, or with CRC scrambled by CS-RNTI with NDI=1, C-RNTI, or MCS-CRNTI or SP-CSI-RNTI.

Example B78 may include the method of Example B72-77 or some other example herein, further comprising applying the enabled or disabled transform precoding for the PUSCH transmission starting from a first slot that is at least N_TP symbols or slots after the last symbol of the PUSCH transmission.

Example B79 may include the method of Example B78 or some other example herein, wherein the first slot and the symbols are determined on the active BWP with the smallest SCS among the active BWP(s) of the carrier(s) applying the enabled or disabled transform precoding.

Example B80 may include a method of a UE, the method comprising:
receiving a DCI to schedule multiple PUSCHs, wherein the DCI indicates whether transform precoding is to be applied for the PUSCHs; and
encoding the PUSCHs for transmission based on the DCI.

Example B81 may include the method of Example B80 or some other example herein, wherein the PUSCHs are scheduled in multiple cells.

Example B82 may include the method of Example B81 or some other example herein, wherein the DCI includes a single bit to indicate whether transform precoding is to be applied for all of the PUSCHs.

Example B83 may include the method of Example B81 or some other example herein, wherein the DCI includes separate bit fields to indicate whether transform precoding is to be applied for the PUSCHs in respective cells.

Example B84 may include the method of Example B80 or some other example herein, wherein the PUSCHs are targeted to multiple TRPs and multiple SRS resource sets are configured with a usage of codebook or non-codebook.

Example B85 may include the method of Example B84 or some other example herein, wherein the DCI includes a single bit to indicate whether transform precoding is to be applied for all of the PUSCHs.

Example B86 may include the method of Example B84 or some other example herein, wherein the DCI includes separate bit fields to indicate whether transform precoding is to be applied for the PUSCHs targeted to the respective TRPs.

Example B87 may include the method of Example B80 or some other example herein, wherein the DCI includes a single bit to indicate whether transform precoding is to be applied for all of the PUSCHs.

Example B88 may include the method of Example B80 or some other example herein, wherein the DCI includes multiple bit fields to indicate whether transform precoding is to be applied for respective subsets of one or more of the PUSCHs.

Example B89 may include the method of Example B88 or some other example herein, wherein the subsets correspond to PUSCHs that are transmitted in respective cells or targeted to respective TRPs.

Example B90 may include the method of Example B80-89 or some other example herein, wherein the DCI includes a waveform indication field, and wherein a size of the waveform indication field is determined in accordance with a maximum number of carriers among all rows of a carrier indication table that is configured with dynamic waveform indication.

Example B91 may include the method of Example B90 or some other example herein, wherein 2 rows (a first row and a second row) are configured for the carrier indication table, wherein the first row is configured with {cell #0, cell #1} and the second row is configured with {cell #0, cell #2}, wherein dynamic waveform indication is configured for cell #0 and cell #1, wherein dynamic waveform indication is not configured for cell #2, and wherein the size of the waveform indication is 2.

Example Z01 may include an apparatus comprising means to perform one or more elements of a method described in or related to any of examples A1-A25, B1-B91, or any other method or process described herein.

Example Z02 may include one or more non-transitory computer-readable media comprising instructions to cause an electronic device, upon execution of the instructions by one or more processors of the electronic device, to perform one or more elements of a method described in or related to any of examples A1-A25, B1-B91, or any other method or process described herein.

Example Z03 may include an apparatus comprising logic, modules, or circuitry to perform one or more elements of a method described in or related to any of examples A1-A25, B1-B91, or any other method or process described herein.

Example Z04 may include a method, technique, or process as described in or related to any of examples A1-A25, B1-B91, or portions or parts thereof.

Example Z05 may include an apparatus comprising: one or more processors and one or more computer-readable media comprising instructions that, when executed by the one or more processors, cause the one or more processors to perform the method, techniques, or process as described in or related to any of examples A1-A25, B1-B91, or portions thereof.

Example Z06 may include a signal as described in or related to any of examples A1-A25, B1-B91, or portions or parts thereof.

Example Z07 may include a datagram, packet, frame, segment, protocol data unit (PDU), or message as described in or related to any of examples A1-A25, B1-B91, or portions or parts thereof, or otherwise described in the present disclosure.

Example Z08 may include a signal encoded with data as described in or related to any of examples A1-A25, B1-B91, or portions or parts thereof, or otherwise described in the present disclosure.

Example Z09 may include a signal encoded with a datagram, packet, frame, segment, protocol data unit (PDU), or message as described in or related to any of examples A1-A25, B1-B91, or portions or parts thereof, or otherwise described in the present disclosure.

Example Z10 may include an electromagnetic signal carrying computer-readable instructions, wherein execution of the computer-readable instructions by one or more processors is to cause the one or more processors to perform the method, techniques, or process as described in or related to any of examples A1-A25, B1-B91, or portions thereof.

Example Z11 may include a computer program comprising instructions, wherein execution of the program by a processing element is to cause the processing element to carry out the method, techniques, or process as described in or related to any of examples A1-A25, B1-B91, or portions thereof.

Example Z12 may include a signal in a wireless network as shown and described herein.

Example Z13 may include a method of communicating in a wireless network as shown and described herein.

Example Z14 may include a system for providing wireless communication as shown and described herein.

Example Z15 may include a device for providing wireless communication as shown and described herein.

Any of the above-described examples may be combined with any other example (or combination of examples), unless explicitly stated otherwise. The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

### Abbreviations

Unless used differently herein, terms, definitions, and abbreviations may be consistent with terms, definitions, and abbreviations defined in 3GPP TR 21.905 v16.0.0 (2019 June). For the purposes of the present document, the following abbreviations may apply to the examples and embodiments discussed herein.

3GPP Third Generation Partnership Project
4G Fourth Generation
5G Fifth Generation
5GC 5G Core network
AC Application Client
ACR Application Context Relocation
ACK Acknowledgement
ACID Application Client Identification
AF Application Function
AM Acknowledged Mode
AMBRAggregate Maximum Bit Rate
AMF Access and Mobility Management Function
AN Access Network
ANR Automatic Neighbour Relation
AOA Angle of Arrival
AP Application Protocol, Antenna Port, Access Point
API Application Programming Interface
APN Access Point Name
ARP Allocation and Retention Priority
ARQ Automatic Repeat Request
AS Access Stratum
ASP Application Service Provider
ASN.1 Abstract Syntax Notation One
AUSF Authentication Server Function
AWGN Additive White Gaussian Noise
BAP Backhaul Adaptation Protocol
BCH Broadcast Channel
BER Bit Error Ratio
BFD Beam Failure Detection
BLER Block Error Rate
BPSK Binary Phase Shift Keying
BRAS Broadband Remote Access Server
BSS Business Support System
BS Base Station
BSR Buffer Status Report
BW Bandwidth
BWP Bandwidth Part
C-RNTI Cell Radio Network Temporary Identity
CA Carrier Aggregation, Certification Authority
CAPEX CAPital Expenditure
CBRA Contention Based Random Access
CC Component Carrier, Country Code, Cryptographic Checksum
CCA Clear Channel Assessment
CCE Control Channel Element
CCCH Common Control Channel
CE Coverage Enhancement
CDM Content Delivery Network
CDMA Code-Division Multiple Access
CDR Charging Data Request
CDR Charging Data Response
CFRA Contention Free Random Access
CG Cell Group
CGF Charging Gateway Function
CHF Charging Function
CI Cell Identity
CID Cell-ID (e.g., positioning method)
CIM Common Information Model
CIR Carrier to Interference Ratio
CK Cipher Key
CM Connection Management, Conditional Mandatory
CMAS Commercial Mobile Alert Service
CMD Command
CMS Cloud Management System
CO Conditional Optional
CoMP Coordinated Multi-Point
CORESET Control Resource Set
COTS Commercial Off-The-Shelf
CP Control Plane, Cyclic Prefix, Connection Point
CPD Connection Point Descriptor
CPE Customer Premise Equipment
CPICHCommon Pilot Channel
CQI Channel Quality Indicator
CPU CSI processing unit, Central Processing Unit
C/R Command/Response field bit
CRAN Cloud Radio Access Network, Cloud RAN
CRB Common Resource Block
CRC Cyclic Redundancy Check
CRI Channel-State Information Resource Indicator,
CSI-RS Resource Indicator
C-RNTI Cell RNTI
CS Circuit Switched
CSCF call session control function
CSAR Cloud Service Archive
CSI Channel-State Information
CSI-IM CSI Interference Measurement
CSI-RS CSI Reference Signal
CSI-RSRP CSI reference signal received power
CSI-RSRQ CSI reference signal received quality
CSI-SINR CSI signal-to-noise and interference ratio
CSMA Carrier Sense Multiple Access
CSMA/CA CSMA with collision avoidance
CSS Common Search Space, Cell-specific Search Space
CTF Charging Trigger Function
CTS Clear-to-Send
CW Codeword
CWS Contention Window Size
D2D Device-to-Device
DC Dual Connectivity, Direct Current
DCI Downlink Control Information
DF Deployment Flavour
DL Downlink
DMTF Distributed Management Task Force
DPDK Data Plane Development Kit
DM-RS, DMRS Demodulation Reference Signal
DN Data network
DNN Data Network Name
DNAI Data Network Access Identifier
DRB Data Radio Bearer
DRS Discovery Reference Signal
DRX Discontinuous Reception
DSL Domain Specific Language. Digital Subscriber Line
DSLAM DSL Access Multiplexer
DwPTS Downlink Pilot Time Slot
E-LAN Ethernet Local Area Network
E2E End-to-End
EAS Edge Application Server
ECCA extended clear channel assessment, extended CCA
ECCE Enhanced Control Channel Element, Enhanced CCE
ED Energy Detection
EDGE Enhanced Datarates for GSM Evolution (GSM Evolution)
EAS Edge Application Server
EASID Edge Application Server Identification
ECS Edge Configuration Server
ECSP Edge Computing Service Provider
EDN Edge Data Network
EEC Edge Enabler Client
EECID Edge Enabler Client Identification
EES Edge Enabler Server
EESID Edge Enabler Server Identification
EHE Edge Hosting Environment
EGMF Exposure Governance Management Function
EGPRS Enhanced GPRS
EIR Equipment Identity Register
eLAA enhanced Licensed Assisted Access, enhanced LAA
EM Element Manager
eMBB Enhanced Mobile Broadband
EMS Element Management System
eNB evolved NodeB, E-UTRAN Node B
EN-DC E-UTRA-NR Dual Connectivity
EPC Evolved Packet Core
EPDCCH enhanced PDCCH, enhanced Physical Downlink Control Cannel
EPRE Energy per resource element
EPS Evolved Packet System
EREG enhanced REG, enhanced resource element groups
ETSI European Telecommunications Standards Institute
ETWS Earthquake and Tsunami Warning System
eUICC embedded UICC, embedded Universal Integrated Circuit Card
E-UTRA Evolved UTRA
E-UTRAN Evolved UTRAN
EV2X Enhanced V2X
F1AP F1 Application Protocol
F1-C F1 Control plane interface
F1-U F1 User plane interface
FACCH Fast Associated Control CHannel
FACCH/F Fast Associated Control Channel/Full rate
FACCH/H Fast Associated Control Channel/Half rate
FACH Forward Access Channel
FAUSCH Fast Uplink Signalling Channel
FB Functional Block
FBI Feedback Information
FCC Federal Communications Commission
FCCH Frequency Correction CHannel
FDD Frequency Division Duplex
FDM Frequency Division Multiplex
FDMAFrequency Division Multiple Access
FE Front End
FEC Forward Error Correction
FFS For Further Study
FFT Fast Fourier Transformation
feLAA further enhanced Licensed Assisted Access, further enhanced LAA
FN Frame Number
FPGA Field-Programmable Gate Array
FR Frequency Range
FQDN Fully Qualified Domain Name
G-RNTI GERAN Radio Network Temporary Identity
GERAN GSM EDGE RAN, GSM EDGE Radio Access Network
GGSN Gateway GPRS Support Node
GLONASS GLObal’naya NAvigatsionnaya Sputnikovaya Sistema
(Engl.: Global Navigation Satellite System)
gNB Next Generation NodeB
gNB-CU gNB-centralized unit, Next Generation NodeB centralized unit
gNB-DU gNB-distributed unit, Next Generation NodeB distributed unit
GNSS Global Navigation Satellite System
GPRS General Packet Radio Service
GPSI Generic Public Subscription Identifier
GSM Global System for Mobile Communications, Groupe Spécial Mobile
GTP GPRS Tunneling Protocol
GTP-UGPRS Tunnelling Protocol for User Plane
GTS Go To Sleep Signal (related to WUS)
GUMMEI Globally Unique MME Identifier
GUTI Globally Unique Temporary UE Identity
HARQ Hybrid ARQ, Hybrid Automatic Repeat Request
HANDO Handover
HFN HyperFrame Number
HHO Hard Handover
HLR Home Location Register
HN Home Network
HO Handover
HPLMN Home Public Land Mobile Network
HSDPA High Speed Downlink Packet Access
HSN Hopping Sequence Number
HSPA High Speed Packet Access
HSS Home Subscriber Server
HSUPA High Speed Uplink Packet Access
HTTP Hyper Text Transfer Protocol
HTTPS Hyper Text Transfer Protocol Secure
(https is http/1.1 over SSL, i.e. port 443)
I-Block Information Block
ICCID Integrated Circuit Card Identification
IAB Integrated Access and Backhaul
ICIC Inter-Cell Interference Coordination
ID Identity, identifier
IDFT Inverse Discrete Fourier Transform
IE Information element
IBE In-Band Emission
IEEE Institute of Electrical and Electronics Engineers
IEI Information Element Identifier
IEIDL Information Element Identifier Data Length
IETF Internet Engineering Task Force
IF Infrastructure
IIOT Industrial Internet of Things
IM Interference Measurement, Intermodulation, IP Multimedia
IMC IMS Credentials
IMEI International Mobile Equipment Identity
IMGI International mobile group identity
IMPI IP Multimedia Private Identity
IMPU IP Multimedia PUblic identity
IMS IP Multimedia Subsystem
IMSI International Mobile Subscriber Identity
IoT Internet of Things
IP Internet Protocol
Ipsec IP Security, Internet Protocol Security
IP-CAN IP-Connectivity Access Network
IP-M IP Multicast
IPv4 Internet Protocol Version 4
IPv6 Internet Protocol Version 6
IR Infrared
IS In Sync
IRP Integration Reference Point
ISDN Integrated Services Digital Network
ISIM IM Services Identity Module
ISO International Organisation for Standardisation
ISP Internet Service Provider
IWF Interworking-Function
I-WLAN Interworking WLAN
Constraint length of the convolutional code, USIM Individual key
kB Kilobyte (1000 bytes)
kbps kilo-bits per second
Kc Ciphering key
Ki Individual subscriber authentication key
KPI Key Performance Indicator
KQI Key Quality Indicator
KSI Key Set Identifier
ksps kilo-symbols per second
KVM Kernel Virtual Machine
L1 Layer 1 (physical layer)
L1-RSRP Layer 1 reference signal received power
L2 Layer 2 (data link layer)
L3 Layer 3 (network layer)
LAA Licensed Assisted Access
LAN Local Area Network
LADN Local Area Data Network
LBT Listen Before Talk
LCM LifeCycle Management
LCR Low Chip Rate
LCS Location Services
LCID Logical Channel ID
LI Layer Indicator
LLC Logical Link Control, Low Layer Compatibility
LMF Location Management Function
LOS Line of Sight
LPLMN Local PLMN
LPP LTE Positioning Protocol
LSB Least Significant Bit
LTE Long Term Evolution
LWA LTE-WLAN aggregation
LWIP LTE/WLAN Radio Level Integration with IPsec Tunnel
LTE Long Term Evolution
M2M Machine-to-Machine
MAC Medium Access Control (protocol layering context)
MAC Message authentication code (security/encryption context)
MAC-A MAC used for authentication and key agreement
(TSG T WG3 context)
MAC-IMAC used for data integrity of signalling messages
(TSG T WG3 context)
MANO Management and Orchestration
MBMS Multimedia Broadcast and Multicast Service
MBSFN Multimedia Broadcast multicast service
Single Frequency Network
MCC Mobile Country Code
MCG Master Cell Group
MCOTMaximum Channel Occupancy Time
MCS Modulation and coding scheme
MDAFManagement Data Analytics Function
MDASManagement Data Analytics Service
MDT Minimization of Drive Tests
ME Mobile Equipment
MeNB master eNB
MER Message Error Ratio
MGL Measurement Gap Length
MGRP Measurement Gap Repetition Period
MIB Master Information Block, Management Information Base
MIMO Multiple Input Multiple Output
MLC Mobile Location Centre
MM Mobility Management
MME Mobility Management Entity
MN Master Node
MNO Mobile Network Operator
MO Measurement Object, Mobile Originated
MPBCH MTC Physical Broadcast CHannel
MPDCCH MTC Physical Downlink Control CHannel
MPDSCH MTC Physical Downlink Shared CHannel
MPRACH MTC Physical Random Access CHannel
MPUSCH MTC Physical Uplink Shared Channel
MPLS MultiProtocol Label Switching
MS Mobile Station
MSB Most Significant Bit
MSC Mobile Switching Centre
MSI Minimum System Information,
MCH Scheduling Information
MSID Mobile Station Identifier
MSIN Mobile Station Identification Number
MSISDN Mobile Subscriber ISDN Number
MT Mobile Terminated, Mobile Termination
MTC Machine-Type Communications
mMTCmassive MTC, massive Machine-Type Communications
MU-MIMO Multi User MIMO
MWUS MTC wake-up signal, MTC WUS
NACK Negative Acknowledgement
NAI Network Access Identifier
NAS Non-Access Stratum, Non- Access Stratum layer
NCT Network Connectivity Topology
NC-JT Non-Coherent Joint Transmission
NEC Network Capability Exposure
NE-DC NR-E-UTRA Dual Connectivity
NEF Network Exposure Function
NF Network Function
NFP Network Forwarding Path
NFPD Network Forwarding Path Descriptor
NFV Network Functions Virtualization
NFVI NFV Infrastructure
NFVO NFV Orchestrator
NG Next Generation, Next Gen
NGEN-DC NG-RAN E-UTRA-NR Dual Connectivity
NM Network Manager
NMS Network Management System
N-PoP Network Point of Presence
NMIB, N-MIB Narrowband MIB
NPBCH Narrowband Physical Broadcast CHannel
NPDCCH Narrowband Physical Downlink Control CHannel
NPDSCH Narrowband Physical Downlink Shared CHannel
NPRACH Narrowband Physical Random Access CHannel
NPUSCH Narrowband Physical Uplink Shared CHannel
NPSS Narrowband Primary Synchronization Signal
NSSS Narrowband Secondary Synchronization Signal
NR New Radio, Neighbour Relation
NRF NF Repository Function
NRS Narrowband Reference Signal
NS Network Service
NSA Non-Standalone operation mode
NSD Network Service Descriptor
NSR Network Service Record
NSSAINetwork Slice Selection Assistance Information
S-NNSAI Single-NSSAI
NSSF Network Slice Selection Function
NW Network
NWUSNarrowband wake-up signal, Narrowband WUS
NZP Non-Zero Power
O&M Operation and Maintenance
ODU2 Optical channel Data Unit - type 2
OFDMOrthogonal Frequency Division Multiplexing
OFDMA Orthogonal Frequency Division Multiple Access
OOB Out-of-Band
OOS Out of Sync
OPEX OPerating EXpense
OSI Other System Information
OSS Operations Support System
OTA over-the-air
PAPR Peak-to-Average Power Ratio
PAR Peak to Average Ratio
PBCH Physical Broadcast Channel
PC Power Control, Personal Computer
PCC Primary Component Carrier, Primary CC
P-CSCF Proxy CSCF
PCell Primary Cell
PCI Physical Cell ID, Physical Cell Identity
PCEF Policy and Charging Enforcement Function
PCF Policy Control Function
PCRF Policy Control and Charging Rules Function
PDCP Packet Data Convergence Protocol,
Packet Data Convergence Protocol layer
PDCCH Physical Downlink Control Channel
PDCP Packet Data Convergence Protocol
PDN Packet Data Network, Public Data Network
PDSCH Physical Downlink Shared Channel
PDU Protocol Data Unit
PEI Permanent Equipment Identifiers
PFD Packet Flow Description
P-GW PDN Gateway
PHICH Physical hybrid-ARQ indicator channel
PHY Physical layer
PLMN Public Land Mobile Network
PIN Personal Identification Number
PM Performance Measurement
PMI Precoding Matrix Indicator
PNF Physical Network Function
PNFD Physical Network Function Descriptor
PNFR Physical Network Function Record
POC PTT over Cellular
PP, PTP Point-to-Point
PPP Point-to-Point Protocol
PRACH Physical RACH
PRB Physical resource block
PRG Physical resource block group
ProSe Proximity Services, Proximity-Based Service
PRS Positioning Reference Signal
PRR Packet Reception Radio
PS Packet Services
PSBCH Physical Sidelink Broadcast Channel
PSDCH Physical Sidelink Downlink Channel
PSCCH Physical Sidelink Control Channel
PSSCH Physical Sidelink Shared Channel
PSFCH physical sidelink feedback channel
PSCell Primary SCell
PSS Primary Synchronization Signal
PSTN Public Switched Telephone Network
PT-RS Phase-tracking reference signal
PTT Push-to-Talk
PUCCH Physical Uplink Control Channel
PUSCH Physical Uplink Shared Channel
QAM Quadrature Amplitude Modulation
QCI QoS class of identifier
QCL Quasi co-location
QFI QoS Flow ID, QoS Flow Identifier
QoS Quality of Service
QPSK Quadrature (Quarternary) Phase Shift Keying
QZSS Quasi-Zenith Satellite System
RA-RNTI Random Access RNTI
RAB Radio Access Bearer, Random Access Burst
RACH Random Access Channel
RADIUS Remote Authentication Dial In User Service
RAN Radio Access Network
RAND RANDom number (used for authentication)
RAR Random Access Response
RAT Radio Access Technology
RAU Routing Area Update
RB Resource block, Radio Bearer
RBG Resource block group
REG Resource Element Group
Rel Release
REQ REQuest
RF Radio Frequency
RI Rank Indicator
RIV Resource indicator value
RL Radio Link
RLC Radio Link Control, Radio Link Control layer
RLC AM RLC Acknowledged Mode
RLC UM RLC Unacknowledged Mode
RLF Radio Link Failure
RLM Radio Link Monitoring
RLM-RS Reference Signal for RLM
RM Registration Management
RMC Reference Measurement Channel
RMSI Remaining MSI, Remaining Minimum System Information
RN Relay Node
RNC Radio Network Controller
RNL Radio Network Layer
RNTI Radio Network Temporary Identifier
ROHC RObust Header Compression
RRC Radio Resource Control, Radio Resource Control layer
RRM Radio Resource Management
RS Reference Signal
RSRP Reference Signal Received Power
RSRQ Reference Signal Received Quality
RSSI Received Signal Strength Indicator
RSU Road Side Unit
RSTD Reference Signal Time difference
RTP Real Time Protocol
RTS Ready-To-Send
RTT Round Trip Time
Rx Reception, Receiving, Receiver
S1AP S1 Application Protocol
S1-MME S1 for the control plane
S1-U S1 for the user plane
S-CSCF serving CSCF
S-GW Serving Gateway
S-RNTI SRNC Radio Network Temporary Identity
S-TMSI SAE Temporary Mobile Station Identifier
SA Standalone operation mode
SAE System Architecture Evolution
SAP Service Access Point
SAPD Service Access Point Descriptor
SAPI Service Access Point Identifier
SCC Secondary Component Carrier, Secondary CC
SCell Secondary Cell
SCEF Service Capability Exposure Function
SC-FDMA Single Carrier Frequency Division Multiple Access
SCG Secondary Cell Group
SCM Security Context Management
SCS Subcarrier Spacing
SCTP Stream Control Transmission Protocol
SDAP Service Data Adaptation Protocol,
Service Data Adaptation Protocol layer
SDL Supplementary Downlink
SDNF Structured Data Storage Network Function
SDP Session Description Protocol
SDSF Structured Data Storage Function
SDT Small Data Transmission
SDU Service Data Unit
SEAF Security Anchor Function
SeNB secondary eNB
SEPP Security Edge Protection Proxy
SFI Slot format indication
SFTD Space-Frequency Time Diversity, SFN and frame timing difference
SFN System Frame Number
SgNB secondary gNB
SGSN Serving GPRS Support Node
S-GW Serving Gateway
SI System Information
SI-RNTI System Information RNTI
SIB System Information Block
SIM Subscriber Identity Module
SIP Session Initiated Protocol
SiP System in Package
SL Sidelink
SLA Service Level Agreement
SM Session Management
SMF Session Management Function
SMS Short Message Service
SMSF SMS Function
SMTC SSB-based Measurement Timing Configuration
SN Secondary Node, Sequence Number
SoC System on Chip
SON Self-Organizing Network
SpCell Special Cell
SP-CSI-RNTISemi-Persistent CSI RNTI
SPS Semi-Persistent Scheduling
SQN Sequence number
SR Scheduling Request
SRB Signalling Radio Bearer
SRS Sounding Reference Signal
SS Synchronization Signal
SSB Synchronization Signal Block
SSID Service Set Identifier
SS/PBCH Block SSBRI SS/PBCH Block Resource Indicator,
Synchronization Signal Block Resource Indicator
SSC Session and Service Continuity
SS-RSRP Synchronization Signal based Reference Signal
Received Power
SS-RSRQ Synchronization Signal based Reference Signal
Received Quality
SS-SINR Synchronization Signal based Signal to Noise
and Interference Ratio
SSS Secondary Synchronization Signal
SSSG Search Space Set Group
SSSIF Search Space Set Indicator
SST Slice/Service Types
SU-MIMO Single User MIMO
SUL Supplementary Uplink
TA Timing Advance, Tracking Area
TAC Tracking Area Code
TAG Timing Advance Group
TAI Tracking Area Identity
TAU Tracking Area Update
TB Transport Block
TBS Transport Block Size
TBD To Be Defined
TCI Transmission Configuration Indicator
TCP Transmission Communication Protocol
TDD Time Division Duplex
TDM Time Division Multiplexing
TDMA Time Division Multiple Access
TE Terminal Equipment
TEID Tunnel End Point Identifier
TFT Traffic Flow Template
TMSI Temporary Mobile Subscriber Identity
TNL Transport Network Layer
TPC Transmit Power Control
TPMI Transmitted Precoding Matrix Indicator
TR Technical Report
TRP, TRxP Transmission Reception Point
TRS Tracking Reference Signal
TRx Transceiver
TS Technical Specifications, Technical Standard
TTI Transmission Time Interval
Tx Transmission, Transmitting, Transmitter
U-RNTI UTRAN Radio Network Temporary Identity
UART Universal Asynchronous Receiver and Transmitter
UCI Uplink Control Information
UE User Equipment
UDM Unified Data Management
UDP User Datagram Protocol
USDF Unstructured Data Storage Network Function
UICC Universal Integrated Circuit Card
UL Uplink
UM Unacknowledged Mode
UML Unified Modelling Language
UMTS Universal Mobile Telecommunications System
UP User Plane
UPF User Plane Function
URI Uniform Resource Identifier
URL Uniform Resource Locator
URLLC Ultra-Reliable and Low Latency
USB Universal Serial Bus
USIM Universal Subscriber Identity Module
USS UE-Specific search space
UTRA UMTS Terrestrial Radio Access
UTRAN Universal Terrestrial Radio Access Network
UwPTS Uplink Pilot Time Slot
V2I Vehicle-to-Infrastruction
V2P Vehicle-to-Pedestrian
V2V Vehicle-to-Vehicle
V2X Vehicle-to-everything
VIM Virtualized Infrastructure Manager
VL Virtual Link,
VLAN Virtual LAN, Virtual Local Area Network
VM Virtual Machine
VNF Virtualized Network Function
VNFFG VNF Forwarding Graph
VNFFGD VNF Forwarding Graph Descriptor
VNFM VNF Manager
VoIP Voice-over-IP, Voice-over- Internet Protocol
VPLMN Visited Public Land Mobile Network
VPN Virtual Private Network
VRB Virtual Resource Block
WiMAX Worldwide Interoperability for Microwave Access
WLANWireless Local Area Network
WMAN Wireless Metropolitan Area Network
WPANWireless Personal Area Network
X2-C X2-Control plane
X2-U X2-User plane
XML eXtensible Markup Language
XRES EXpected user RESponse
XOR eXclusive OR
ZC Zadoff-Chu
ZP Zero Power

### Terminology

For the purposes of the present document, the following terms and definitions are applicable to the examples and embodiments discussed herein.

The term “application” may refer to a complete and deployable package, environment to achieve a certain function in an operational environment. The term “AI/ML application” or the like may be an application that contains some AI/ML models and application-level descriptions.

The term “circuitry” as used herein refers to, is part of, or includes hardware components such as an electronic circuit, a logic circuit, a processor (shared, dedicated, or group) and/or memory (shared, dedicated, or group), an Application Specific Integrated Circuit (ASIC), a field-programmable device (FPD) (e.g., a field-programmable gate array (FPGA), a programmable logic device (PLD), a complex PLD (CPLD), a high-capacity PLD (HCPLD), a structured ASIC, or a programmable SoC), digital signal processors (DSPs), etc., that are configured to provide the described functionality. In some embodiments, the circuitry may execute one or more software or firmware programs to provide at least some of the described functionality. The term “circuitry” may also refer to a combination of one or more hardware elements (or a combination of circuits used in an electrical or electronic system) with the program code used to carry out the functionality of that program code. In these embodiments, the combination of hardware elements and program code may be referred to as a particular type of circuitry.

The term “processor circuitry” as used herein refers to, is part of, or includes circuitry capable of sequentially and automatically carrying out a sequence of arithmetic or logical operations, or recording, storing, and/or transferring digital data. Processing circuitry may include one or more processing cores to execute instructions and one or more memory structures to store program and data information. The term “processor circuitry” may refer to one or more application processors, one or more baseband processors, a physical central processing unit (CPU), a single-core processor, a dual-core processor, a triple-core processor, a quad-core processor, and/or any other device capable of executing or otherwise operating computer-executable instructions, such as program code, software modules, and/or functional processes. Processing circuitry may include more hardware accelerators, which may be microprocessors, programmable processing devices, or the like. The one or more hardware accelerators may include, for example, computer vision (CV) and/or deep learning (DL) accelerators. The terms “application circuitry” and/or “baseband circuitry” may be considered synonymous to, and may be referred to as, “processor circuitry.”

The term “interface circuitry” as used herein refers to, is part of, or includes circuitry that enables the exchange of information between two or more components or devices. The term “interface circuitry” may refer to one or more hardware interfaces, for example, buses, I/O interfaces, peripheral component interfaces, network interface cards, and/or the like.

The term “user equipment” or “UE” as used herein refers to a device with radio communication capabilities and may describe a remote user of network resources in a communications network. The term “user equipment” or “UE” may be considered synonymous to, and may be referred to as, client, mobile, mobile device, mobile terminal, user terminal, mobile unit, mobile station, mobile user, subscriber, user, remote station, access agent, user agent, receiver, radio equipment, reconfigurable radio equipment, reconfigurable mobile device, etc. Furthermore, the term “user equipment” or “UE” may include any type of wireless/wired device or any computing device including a wireless communications interface.

The term “network element” as used herein refers to physical or virtualized equipment and/or infrastructure used to provide wired or wireless communication network services. The term “network element” may be considered synonymous to and/or referred to as a networked computer, networking hardware, network equipment, network node, router, switch, hub, bridge, radio network controller, RAN device, RAN node, gateway, server, virtualized VNF, NFVI, and/or the like.

The term “computer system” as used herein refers to any type interconnected electronic devices, computer devices, or components thereof. Additionally, the term “computer system” and/or “system” may refer to various components of a computer that are communicatively coupled with one another. Furthermore, the term “computer system” and/or “system” may refer to multiple computer devices and/or multiple computing systems that are communicatively coupled with one another and configured to share computing and/or networking resources.

The term “appliance,” “computer appliance,” or the like, as used herein refers to a computer device or computer system with program code (e.g., software or firmware) that is specifically designed to provide a specific computing resource. A “virtual appliance” is a virtual machine image to be implemented by a hypervisor-equipped device that virtualizes or emulates a computer appliance or otherwise is dedicated to provide a specific computing resource.

The term “resource” as used herein refers to a physical or virtual device, a physical or virtual component within a computing environment, and/or a physical or virtual component within a particular device, such as computer devices, mechanical devices, memory space, processor/CPU time, processor/CPU usage, processor and accelerator loads, hardware time or usage, electrical power, input/output operations, ports or network sockets, channel/link allocation, throughput, memory usage, storage, network, database and applications, workload units, and/or the like. A “hardware resource” may refer to compute, storage, and/or network resources provided by physical hardware element(s). A “virtualized resource” may refer to compute, storage, and/or network resources provided by virtualization infrastructure to an application, device, system, etc. The term “network resource” or “communication resource” may refer to resources that are accessible by computer devices/systems via a communications network. The term “system resources” may refer to any kind of shared entities to provide services, and may include computing and/or network resources. System resources may be considered as a set of coherent functions, network data objects or services, accessible through a server where such system resources reside on a single host or multiple hosts and are clearly identifiable.

The term “channel” as used herein refers to any transmission medium, either tangible or intangible, which is used to communicate data or a data stream. The term “channel” may be synonymous with and/or equivalent to “communications channel,” “data communications channel,” “transmission channel,” “data transmission channel,” “access channel,” “data access channel,” “link,” “data link,” “carrier,” “radiofrequency carrier,” and/or any other like term denoting a pathway or medium through which data is communicated. Additionally, the term “link” as used herein refers to a connection between two devices through a RAT for the purpose of transmitting and receiving information.

The terms “instantiate,” “instantiation,” and the like as used herein refers to the creation of an instance. An “instance” also refers to a concrete occurrence of an object, which may occur, for example, during execution of program code.

The terms “coupled,” “communicatively coupled,” along with derivatives thereof are used herein. The term “coupled” may mean two or more elements are in direct physical or electrical contact with one another, may mean that two or more elements indirectly contact each other but still cooperate or interact with each other, and/or may mean that one or more other elements are coupled or connected between the elements that are said to be coupled with each other. The term “directly coupled” may mean that two or more elements are in direct contact with one another. The term “communicatively coupled” may mean that two or more elements may be in contact with one another by a means of communication including through a wire or other interconnect connection, through a wireless communication channel or link, and/or the like.

The term “information element” refers to a structural element containing one or more fields. The term “field” refers to individual contents of an information element, or a data element that contains content.

The term “SMTC” refers to an SSB-based measurement timing configuration configured by SSB-MeasurementTimingConfiguration.

The term “SSB” refers to an SS/PBCH block.

The term “a “Primary Cell” refers to the MCG cell, operating on the primary frequency, in which the UE either performs the initial connection establishment procedure or initiates the connection re-establishment procedure.

The term “Primary SCG Cell” refers to the SCG cell in which the UE performs random access when performing the Reconfiguration with Sync procedure for DC operation.

The term “Secondary Cell” refers to a cell providing additional radio resources on top of a Special Cell for a UE configured with CA.

The term “Secondary Cell Group” refers to the subset of serving cells comprising the PSCell and zero or more secondary cells for a UE configured with DC.

The term “Serving Cell” refers to the primary cell for a UE in RRC_CONNECTED not configured with CA/DC there is only one serving cell comprising of the primary cell.

The term “serving cell” or “serving cells” refers to the set of cells comprising the Special Cell(s) and all secondary cells for a UE in RRC_CONNECTED configured with CA/.

The term “Special Cell” refers to the PCell of the MCG or the PSCell of the SCG for DC operation; otherwise, the term “Special Cell” refers to the Pcell.

The term “machine learning” or “ML” refers to the use of computer systems implementing algorithms and/or statistical models to perform specific task(s) without using explicit instructions, but instead relying on patterns and inferences. ML algorithms build or estimate mathematical model(s) (referred to as “ML models” or the like) based on sample data (referred to as “training data,” “model training information,” or the like) in order to make predictions or decisions without being explicitly programmed to perform such tasks. Generally, an ML algorithm is a computer program that learns from experience with respect to some task and some performance measure, and an ML model may be any object or data structure created after an ML algorithm is trained with one or more training datasets. After training, an ML model may be used to make predictions on new datasets. Although the term “ML algorithm” refers to different concepts than the term “ML model,” these terms as discussed herein may be used interchangeably for the purposes of the present disclosure.

The term “machine learning model,” “ML model,” or the like may also refer to ML methods and concepts used by an ML-assisted solution. An “ML-assisted solution” is a solution that addresses a specific use case using ML algorithms during operation. ML models include supervised learning (e.g., linear regression, k-nearest neighbor (KNN), decision tree algorithms, support machine vectors, Bayesian algorithm, ensemble algorithms, etc.) unsupervised learning (e.g., K-means clustering, principle component analysis (PCA), etc.), reinforcement learning (e.g., Q-learning, multi-armed bandit learning, deep RL, etc.), neural networks, and the like. Depending on the implementation a specific ML model could have many sub-models as components and the ML model may train all sub-models together. Separately trained ML models can also be chained together in an ML pipeline during inference. An “ML pipeline” is a set of functionalities, functions, or functional entities specific for an ML-assisted solution; an ML pipeline may include one or several data sources in a data pipeline, a model training pipeline, a model evaluation pipeline, and an actor. The “actor” is an entity that hosts an ML assisted solution using the output of the ML model inference). The term “ML training host” refers to an entity, such as a network function, that hosts the training of the model. The term “ML inference host” refers to an entity, such as a network function, that hosts model during inference mode (which includes both the model execution as well as any online learning if applicable). The ML-host informs the actor about the output of the ML algorithm, and the actor takes a decision for an action (an “action” is performed by an actor as a result of the output of an ML assisted solution). The term “model inference information” refers to information used as an input to the ML model for determining inference(s); the data used to train an ML model and the data used to determine inferences may overlap, however, “training data” and “inference data” refer to different concepts.

1.-25. (canceled)

26. An apparatus for use in a user equipment (UE), wherein the apparatus comprises:
memory to story a received downlink control information (DCI) that schedules a physical uplink shared channel (PUSCH), wherein the DCI includes a field to indicate whether transform precoding is enabled or disabled for the PUSCH; and
one or more processors to encode the PUSCH for transmission based on the field.

27. The apparatus of claim 26, wherein the DCI is a DCI format 0_0, a DCI format 0_1, or a DCI format 0_2.

28. The apparatus of claim 26, wherein the DCI has a cyclic redundancy check (CRC) scrambled by a cell (C)-radio network temporary identifier (RNTI), a configured scheduling (CS)-RNTI with a new data indicator having a value of 1, or a modulation and coding scheme (MCS)-C-RNTI.

29. The apparatus of claim 26, wherein the field is one bit.

30. The apparatus of claim 26, wherein the one or more processors are further to identify configuration information to indicate whether the field is to be present in the DCI.

31. The apparatus of claim 26, wherein the PUSCH is included in a Msg3 of a random access procedure.

32. The apparatus of claim 26, wherein the PUSCH is a first PUSCH, wherein the DCI schedules multiple PUSCHs in a cell including the first PUSCH, and wherein the field indicates whether transform precoding is enabled or disabled for all of the multiple PUSCHs.

33. The apparatus of claim 26, wherein the field is a first field, and wherein the one or more processors are further to determine a size of a second field of the DCI as a larger of a first size that is used for a cyclic prefix (CP)-orthogonal frequency division multiplexing (OFDM) waveform and a second size that is used for a discrete Fourier transform (DFT)-spread (s)-OFDM waveform.

34. The apparatus of claim 26, wherein the one or more processors are further to determine an overall size of the DCI as a larger of a first DCI size that is used for a cyclic prefix (CP)-orthogonal frequency division multiplexing (OFDM) waveform and a second DCI size that is used for a discrete Fourier transform (DFT)-spread (s)-OFDM waveform.

35. The apparatus of claim 34, wherein the field is at the beginning of the DCI to indicate whether the DCI corresponds to the CP-OFDM waveform or the DFT-s-OFDM waveform.

36. One or more non-transitory computer-readable media (NTCRM) having instructions, stored thereon, that when executed by one or more processors of a next generation Node B (gNB) configure the gNB to:
encode, for transmission to a user equipment (UE), a downlink control information (DCI) that schedules a physical uplink shared channel (PUSCH), wherein the DCI includes a field to indicate whether transform precoding is enabled or disabled for the PUSCH; and
decode the PUSCH based on the field.

37. The one or more NTCRM of claim 36, wherein the DCI is a DCI format 0_0, a DCI format 0_1, or a DCI format 0_2.

38. The one or more NTCRM of claim 36, wherein the DCI has a cyclic redundancy check (CRC) scrambled by a cell (C)-radio network temporary identifier (RNTI), a configured scheduling (CS)-RNTI with a new data indicator having a value of 1, or a modulation and coding scheme (MCS)-C-RNTI.

39. The one or more NTCRM of claim 36, wherein the field is one bit.

40. The one or more NTCRM of claim 36, wherein the instructions, when executed, are further to configure the gNB to transmit configuration information to the UE to indicate whether the field is to be present in the DCI.

41. The one or more NTCRM of claim 36, wherein the PUSCH is included in a Msg3 of a random access procedure.

42. The one or more NTCRM of claim 36, wherein the PUSCH is a first PUSCH, wherein the DCI schedules multiple PUSCHs in a cell including the first PUSCH, and wherein the field indicates whether transform precoding is enabled or disabled for all of the multiple PUSCHs.

43. The one or more NTCRM of claim 36, wherein the field is a first field, and wherein to encode the DCI includes to determine a size of a second field of the DCI as a larger of a first size that is used for a cyclic prefix (CP)-orthogonal frequency division multiplexing (OFDM) waveform and a second size that is used for a discrete Fourier transform (DFT)-spread (s)-OFDM waveform.

44. The one or more NTCRM of claim 36, wherein to encode the DCI includes to determine an overall size of the DCI as a larger of a first DCI size that is used for a cyclic prefix (CP)-orthogonal frequency division multiplexing (OFDM) waveform and a second DCI size that is used for a discrete Fourier transform (DFT)-spread (s)-OFDM waveform.

45. The one or more NTCRM of claim 44, wherein the DCI includes a waveform indication field at the beginning of the DCI to indicate whether the DCI corresponds to the CP-OFDM waveform or the DFT-s-OFDM waveform.
